(19) United States
(12) Patent Application Publication
(10) Pub. No.: US 2025/0201454 A1
(43) Pub. Date: Jun. 19, 2025

(54) GENERAL MAGNETIC ASSEMBLY APPROACH TO CHIRAL STRUCTURES AT ALL SCALES

(71) Applicant: The Regents of the University of California, Oakland, CA (US)

(72) Inventors: Yadong Yin, Oakland, CA (US); Zhiwei Li, Oakland, CA (US)

(21) Appl. No.: 18/991,259

(22) Filed: Dec. 20, 2024

Related U.S. Application Data
(60) Provisional application No. 63/611,835, filed on Dec. 19, 2023.

(51) Int. Cl. H01F 1/00; B82B 3/00; B82Y 20/00; B82Y 25/00; H01F 1/42

(52) U.S. Cl. CPC H01F 1/0036; B82B 3/0038; B82B 3/0066; B82Y 20/00; B82Y 25/00; H01F 1/42

(57) ABSTRACT

A method of assembling a chiral superstructure includes applying a quadrupole magnetic field to a plurality of magnetic nanostructures and configuring the plurality of magnetic nanostructures into a chiral superstructure by controlling a magnitude and a direction of the quadrupole magnetic field. A magnetic chiral superstructure includes a plurality of magnetic nanostructures assembled into a chiral superstructure by applying a quadrupole magnetic field to the plurality of magnetic nanostructures and configuring the plurality of magnetic nanostructures into a chiral superstructure by controlling a magnitude and a direction of the quadrupole magnetic field.

### CROSS REFERENCE TO RELATED APPLICATIONS

This application claims the benefit of priority of U.S. Provisional Patent Application No. 63/611,835, filed Dec. 19, 2023, which is incorporated herein by reference in its entirety.

### STATEMENT REGARDING FEDERALLY SPONSORED RESEARCH

This invention was made with government support under Grant No. CHE-2203972 awarded by U.S. National Science Foundation. The government has certain rights in the invention.

### TECHNICAL FIELD

This patent document relates to compositions and processes for magnetic assembly of chiral structures at all scales.

### BACKGROUND

Chiral superstructures, which break spatial symmetries at the nanoscale, exhibit unique chiroptical properties and have potential applications in chiral resolution, optical display, biosensing, and chiral catalysis. Typically, chiral additives, such as, for example, chiral molecules, chiral templates, and chiral light, are used to induce chirality in achiral inorganic building blocks, which is then retained in the assembled structure. In recent years, other methods of imparting chirality on self-assembled structures of achiral building blocks have been developed including applying clockwise or counterclockwise mechanical force to nanorod assemblies to induce handedness. However, there still exists a need for a broadly applicable and simple approach to chiral superstructure assembly.

### SUMMARY

Compositions and processes for magnetic assembly of chiral structures are described herein.

In one example aspect, a disclosed method includes applying a quadrupole magnetic field to a plurality of magnetic nanostructures and configuring the plurality of magnetic nanostructures into a chiral superstructure by controlling a magnitude and a direction of the quadrupole magnetic field.

In another example aspect, a magnetic chiral superstructure includes a plurality of magnetic nanostructures assembled into a chiral superstructure by applying a quadrupole magnetic field to the plurality of magnetic nanostructures and controlling a magnitude and a direction of the quadrupole magnetic field to configure the plurality of magnetic nanostructures into a chiral superstructure.

These and other aspects and associated implementations and benefits of the disclosed technology are described in greater detail in the drawings, the description, and the claims.

### BRIEF DESCRIPTION OF THE DRAWINGS

This application contains at least one drawing executed in color. Copies of this application with color drawing(s) will be provided by the Office upon request and payment of the necessary fees.

FIG. 1A shows the normalized magnetic field (white arrows) and field vector azimuth (color map) of a permanent cubic magnet with an edge length of 2 cm.

FIG. 1B shows the field rotating vectors (black arrows) and field angle changes (color map) of the magnetic field in FIG. 1A along the x-axis. Positive rotation angles (Δω) represent clockwise left-handed rotation of the magnetic field, and negative rotation angles represent counterclockwise right-handed field rotation.

FIG. 1C is a schematic illustration of a pathway near a cubic permanent magnet and the chiral field distribution of the magnetic field along the pathway.

FIG. 1D is a schematic illustration of a magnetic assembly in accordance with the present technology during CD measurement and simulated helical superstructures assembled from magnetic nanorods under such a chiral magnetic field.

FIG. 1E shows the extinction spectrum of Fe₃O₄@SiO₂ nanorods under different magnetic fields.

FIG. 1F shows the CD spectrum of Fe₃O₄@SiO₂ nanorods under different magnetic fields.

FIG. 1G is a graph showing the g-factor of chiral superstructures from a magnetic assembly in accordance with the present technology.

FIG. 2A shows the extinction spectra of Fe₃@SiO₂ nanorods in accordance with the present technology.

FIG. 2B shows the CD spectra of Fe₃@SiO₂ nanorods in accordance with the present technology.

FIG. 3A shows SEM images of Fe₃@SiO₂ nanorod (322.2±16.5 nm in length, 70.2±4.7 nm in diameter) alignment at x axes 1, 4, 7, 8, 9, and 10 cm at high magnification.

FIG. 3B shows SEM images of Fe₃@SiO₂ nanorod (107.6±5.2 nm in length, 13.0±1.7 nm in diameter) alignment at x axes 1, 4, 7, 8, 9, and 10 cm at high magnification.

FIG. 3C shows a summary of simulated and measured nanorod alignment angle at different x axes

FIG. 3D shows the correlation between the measured alignment angles of nanorods of 322 nm in length with the simulated alignment angles.

FIG. 3E shows the correlation between the measured alignment angles of nanorods of 107 nm in length with the simulated alignment angles.

FIG. 4A shows a TEM image of Fe₃O₄/Au hybrid nanorods in accordance with the present technology wrapped within polymer shells.

FIG. 4B shows elemental mapping of hybrid nanorods in accordance with the present technology.

FIG. 4C shows the corresponding line profile of the element distribution of the hybrid nanorods in FIG. 4B.

FIG. 4D shows the extinction spectra of hybrid nanorods containing AU nanorods with two different aspect ratios in accordance with the present technology.

FIG. 4E shows the CD spectra of hybrid nanorods under different magnetic field conditions.

FIG. 4F sows the CD spectra of hybrid nanorods using two identical permanent magnets in an attraction configuration.

FIG. 4G shows the CD spectra of films containing random nanorods.

FIG. 4H shows the CD spectra of films containing unidirectionally aligned nanorods.

FIG. 4I shows the CD spectra of films containing chiral superstructures that were formed by applying a magnet with its magnetic dipole being parallel to the y-axis (By).

FIG. 5A is a schematic illustration of the magnet position during CD measurement.

FIG. 5B shows CD spectra of the Fe₃O₄/Au hybrid nanorods in accordance with the present technology obtained by changing the magnet position.

FIG. 5C shows C spectra of Fe₃O₄/Au hybrid nanorods in accordance with the present technology under magnetic fields with consistent direction and decreasing strength.

FIG. 5D shows dependence of C intensity on the field strength and rod aspect ratios.

FIG. 5E shows simulated field distributions of a cubic magnet at given distances to the magnet surface.

FIG. 5F shows rotation angles of magnetic fields between two y-z cross sections, (−0.2, y, z) and (−0.8, y, z) with a horizontal magnetic dipole.

FIG. 5G shows corresponding field rotation angles (color map) and the local magnetic field at the cross section (−0.2, y, z) of the magnetic field shown in FIG. 5F.

FIG. 5H shows rotation angles of magnetic fields between two y-z cross sections, (−0.2, y, z) and (−0.8, y, z) with a vertical magnetic dipole.

FIG. 5I shows corresponding field rotation angles (color map) and the local magnetic field at the cross section (−0.2, y, z) of the magnetic field shown in FIG. 5H.

FIG. 6A shows the simulated CD spectra of two Au nanorods in accordance with the present technology at a separation of 200 nm and different rotation angles.

FIG. 6B shows the simulated CD spectra of chiral superstructures made of five Au nanorods with random x-, y-, and z-coordinates with increasing ω.

FIG. 6C shows the simulated CD spectra of chiral superstructures made of twenty-five nanorods with only rotational order but no positional order with increasing ω.

FIG. 7A is a schematic illustration of the azimuth changes of a cubic permanent magnet within the x-y and y-z plane during CD measurements.

FIG. 7B shows the CD spectra of Fe₃O₄/Au hybrid nanorods in accordance with the present technology measured by changing the magnet azimuth in the x-y plane.

FIG. 7C shows the magnetic field of the cubic magnet in the y-z plane. The azimuth of the magnet is 0° to 30°, 60°, and 90° from the left to the right panel.

FIG. 7D shows the magnetic field of the cubic magnet in the x-z plane. The azimuth of the magnet is 0° to 30°, 60°, and 90° from the left to the right panel.

FIG. 7E shows the predicted longitudinal extinction of the nanorods based on the analytical solution.

FIG. 7F shows dependence of the CD intensity on magnetic field azimuth.

FIG. 8A shows CD spectra of Fe₃O₄/Au hybrid nanorods in accordance with the present technology measured by changing the magnetic azimuth in the y-z plane.

FIG. 8B shows the magnetic field rotation (color map) and the normalized vectors (arrows) of a cubic magnet.

FIG. 8C shows dependence of field rotation on the magnet field azimuth.

FIG. 8D shows dependence of the CD peak intensity on the magnet field azimuth.

FIG. 8E is a schematic illustration of ORD measurement.

FIG. 8F shows digital images of a hybrid nanorod dispersion in a cuvette without (w/o mag) and with (w/mag) a magnetic field.

FIG. 8G shows digital images of a Fe₃O₄/Au hybrid nanorod dispersion under different magnetic field conditions.

FIG. 9A shows a TEM image of Fe₃O₄@SiO₂@MnO₂ core/shell nanorods in accordance with the present technology.

FIG. 9B shows extinction spectra of Fe₃O₄@SiO₂ and Fe₃O₄@SiO₂@RF core/shell nanorods Fe₃O₄@MnO₂ yolk/shell nanorods, and Fe₃O₄@SiO₂@Cu₂O core/satellite nanorods.

FIG. 9C shows CD spectra measured under y- and z-directional magnetic fields of Fe₃O₄@SiO₂ and Fe₃O₄@SiO₂@RF core/shell nanorods Fe₃O₄@MnO₂ yolk/shell nanorods, and Fe₃O₄@SiO₂@Cu₂O core/satellite nanorods.

FIG. 9D shows extinction spectra of Fe₃O₄@SiO₂@RF nanorods and nanorods doped with the three organic dyes (methylene blue, methylene green, and neutral red).

FIG. 9E shows CD spectra of the doped and undoped nanorods under y- and z-directional magnetic fields.

FIG. 9F shows the g-factor of the doped nanorods under a z-directional magnetic field.

FIG. 10A shows a TEM image of Fe₃O₄ coated Eu—NaYF₄ nanorods in accordance with the present technology.

FIG. 10B show the extinction spectrum of the nanorods of FIG. 10A.

FIG. 10C shows the CD spectra of the nanorods of FIG. 10A measured with the magnetic field along the x and y axes.

FIG. 10D shows the fluorescence spectra of the nanorods of FIG. 10A.

FIG. 10E shows the circularly polarized luminescence spectra of the nanorods of FIG. 10A.

FIG. 11A shows the TEM image of Ag@Fe₃O₄ nanoparticles in accordance with the present technology.

FIG. 11B is a schematic illustration of the setup of extinction and CD measurement under the hB.

FIG. 11C shows extinction spectra of Ag@Fe₃O₄ nanoparticle solution without and with left- and right-handed 90°−hB.

FIG. 11D shows CD spectra of Ag@Fe₃O₄ nanoparticle solution without and with left- and right-handed 90°−hB.

FIG. 11E shows the g-factor of Ag@Fe₃O₄ nanoparticle solution without and with left- and right-handed 90°−hB.

FIG. 12A shows CD spectra of a Ag@Fe₃O₄ nanoparticle assembly in accordance with the present technology under left-handed 90°−hB with varying strength.

FIG. 12B shows dipole and quadrupole peak shifts of a Ag@Fe₃O₄ nanoparticle assembly under left-handed 90°−hB with varying strength.

FIG. 12C shows the peak intensity changes of a Ag@Fe₃O₄ nanoparticle assembly under left-handed 90°−hB with varying strength.

FIG. 12D shows CD spectra of a Ag@Fe₃O₄ nanoparticle assembly under 0°−hB with varying strength.

FIG. 12E shows dipole and quadrupole peak shifts of a Ag@Fe₃O₄ nanoparticle assembly under 0°−hB with varying strength.

FIG. 12F shows the peak intensity changes of a Ag@Fe₃O₄ nanoparticle assembly under 0°−hB with varying strength.

FIG. 12G shows a simulation of a magnetic field vector rotation along the x-axis under different distances.

FIG. 13A shows (i) a schematic illustration of fixing plasmonic chiral superstructures into a polymer film, and (ii) a photo image of an assembled chiral film in accordance with the present technology.

FIG. 13B shows CD spectra of the chiral film of FIG. 8A with left- and right-handedness.

FIG. 13C shows ORD images of the left- and right-handed chiral film of FIG. 8A under varying b from −10.5° to 10.5°.

FIG. 13D shows a scheme of ORD images of a chiral film pattern with left-handed chiral nanostructure in white regions and right-handed chiral nanostructure in black regions at b=0 and ±4.5°.

FIG. 13E shows ORD images of the chiral film of FIG. 8A as the angle between light direction and film varied from 90° to 15° at β==1.5°.

FIG. 13F shows the transmission spectra of the chiral film of FIG. 8A as the angle between light direction and film varied from 90° to 15° at β=−1.5°.

FIG. 13G shows the transmission spectra of the chiral film of FIG. 8A as the angle between light direction and film varied from 90° to 15° at β=1.5°.

FIG. 13H shows ORD images of the chiral film of FIG. 8A under stretching from 0 to 91% as β=−1.5°.

FIG. 13I shows the transmission spectra of the chiral film of FIG. 8A under stretching from 0 to 91% as β=−1.5°.

### DETAILED DESCRIPTION

Assembly of colloidal particles into chiral superstructures is typically achieved using particles or structures that are intrinsically chiral or are rendered chiral with adsorbed surface molecules and templates that create chirality (e.g., helical structures) or by lithographic methods. Chiral superstructures have distinctive optical properties such as circular dichroism (CD) under circularly polarized light excitation, which have the potential for developing electric and optical sensors and devices. Templated assembly and lithography have been used to create chiral superstructures for sensing external stimuli through changes in CD spectra. For example, DNA-templated assembly can transfer the helical configuration of DNA templates to many nanostructures and be used to monitor changes in temperature and chemical binding.

Various bottom-up strategies have been developed to build inorganic chiral superstructures based on the intrinsic configurational preference of the building blocks, external fields, or chiral templates. However, controlling the collective orientation of these chiral structures in either solution or solid matrices remains challenging for optimizing chiroptical performance.

Existing strategies for forming chiral structures such as templated assemblies and chiral superlattice formation only work for materials of narrow length scales and specific chemical compositions or shapes (e.g., uniform inorganic building blocks). Unlocking the potential for designing miniature chiroptical devices and understanding light-matter interactions involving distinct physical principles would benefit from a general approach for assembling achiral materials of diverse sizes, shapes, and chemical compositions into chiral superstructures with actively tunable chiroptical responses.

The present technology discloses a general method for the rapid and reversible assembly of materials of varying compositions and length scales from small molecules to nano- and microstructures into chiral structures with active tuning of the structural handedness, collective orientation, and chiroptical properties using the magnetic field of a permanent magnet or an electromagnet. An analytical model has been developed, which demonstrates the presence of a quadrupole field chirality in the gradient magnetic field of a magnet. Assembling nanostructures such as, for example, nanoparticles, nanorods, or nanodiscs, in such a magnetic field leads to the formation of chiral superstructures, with their handedness and chiroptical properties being determined by magnet position and orientation. This general method is feasible to nanostructures of different sizes and shapes. In addition, the structural chirality of the magnetic chiral structure is transferrable to organic molecules and inorganic compounds by doping into or coating onto the host magnetic building blocks.

In one aspect, the present technology provides a method of assembling a chiral superstructure, comprising applying a quadrupole magnetic field to a plurality of magnetic nanostructures and configuring the plurality of magnetic nanostructures into a chiral superstructure by controlling a magnitude and a direction of the quadrupole magnetic field.

In another aspect, the present technology provides a magnetic chiral superstructure comprising a plurality of magnetic nanostructures assembled into a chiral superstructure by applying a quadrupole magnetic field to the plurality of magnetic nanostructures and configuring the plurality of magnetic nanostructures into a chiral superstructure by controlling a magnitude and a direction of the quadrupole magnetic field.

The quadrupole magnetic field may be generated by any magnet capable of generating a quadrupole magnetic field. In some embodiments the magnet is an electromagnet or a permanent magnet. Non-limiting examples of electromagnets and permanent magnets that may be used in methods of the present technology include cube magnets, horseshoe magnets, bar magnets, and ring magnets. In some embodiments, the quadrupole magnetic field is generated from a cube magnet.

The plurality of magnetic nanostructures may comprise one or more of magnetic nanorods, magnetic nanoparticles, or magnetic nanodiscs. The size and shape of the magnetic nanostructures are not particularly limited. Further, the size and/or shape of the magnetic nanostructures may be uniform or non-uniform. For example, in some embodiments, the magnetic nanostructures in the plurality of magnetic nanostructures have a narrow size distribution. In other embodiments, the magnetic nanostructures in the plurality of magnetic nanostructures have a wide size distribution. In some embodiments, the magnetic nanostructures are all nanoparticles. In other embodiments, the magnetic nanostructures are all nanorods. In other embodiments, the magnetic nanostructures are all nanodiscs. In still other embodiments, some of the magnetic nanostructures in the plurality of magnetic nanostructures are nanorods and some of the magnetic nanostructures are nanoparticles. Any combination of shapes and sizes of magnetic nanostructures is envisioned in the present technology.

Each of the magnetic nanostructures may have a magnetic core and a non-magnetic shell. In some embodiments, the non-magnetic shell is a polymer shell. Any polymer commonly used as a shell or coating for inorganic materials may be used in the polymer shell. In some embodiments, the magnetic core comprises Fe₂O₃. In some embodiments, the magnetic core is a hybrid magnetic core, e.g., comprises two or more materials. Suitable hybrid magnetic cores include Fe₂O₃/Au, Fe₂O₃/Ag, Fe₂O₃@SiO₂, among others.

In some embodiments, the plurality of magnetic nanostructures comprises a guest material. The guest material may be doped into the magnetic nanostructures or otherwise added to the plurality of magnetic nanostructures. Suitable guest materials that may be doped into the magnetic nanostructures include organic molecules, polymers, oxides, and semiconductors. Guest materials may be incorporated into the plurality of magnetic nanoparticles to impart the nanoparticles with certain properties, such as, for example, optical properties. Accordingly, in some embodiments, the guest material is an optically active material, such as, e.g., an organic dye. The guest material may be incorporated into the plurality of magnetic nanostructures at any ratio, provided that the guest material does not interfere with the magnetic assembly of the chiral superstructure. For example, the ratio of guest material to magnetic nanostructures can be 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, or 10:1.

In some embodiments, when the plurality magnetic nanoparticles comprises a guest material, the method further comprises transferring the chirality of the magnetic chiral superstructure to the guest material. As such, the method may be applied to, and induce chirality in, achiral organic molecules.

In some embodiments, one or more properties of the chiral superstructure may be tuned by controlling the magnitude and the direction of the quadrupole magnetic field. Moving the magnet closer to the plurality of magnetic nanostructures may increase, whereas moving the magnet further from the plurality of magnetic nanostructures may decrease the magnitude of the magnetic field. Similarly, by changing the position of the magnet from left to right, right to left, above to below, or below to above relative to the plurality of magnetic nanostructures, the direction of the magnetic field may be controlled. Properties that may be tuned by controlling the magnitude and direction of the magnetic field include, but are not limited to, chirality, orientation, shape, and chiroptical properties.

The chiral superstructure may be fixed in a polymeric matrix. Any suitable polymeric matrix known in the art may be used to fix the chiral superstructure. In some embodiments, the chiral superstructure is fixed in a polyacrylamide matrix. A magnetic chiral superstructure may be fixed into a polymer matrix so that it may be used in optical applications. In some embodiments, the chiral superstructure is fixed in a polymer matrix for use in anticounterfeiting applications.

### Examples

The following examples, which include magnetic assemblies, as well as materials, methods of preparation, and procedures for calculating magnetic fields of the same, in accordance with the present technology are described in and/or adapted from Zhiwei Li et al., A magnetic assembly approach to chiral superstructures. Science 380, 1384-1390 (2023), which is incorporated herein by reference in its entirety.

### The Quadrupole Field Chirality of Permanent Magnets

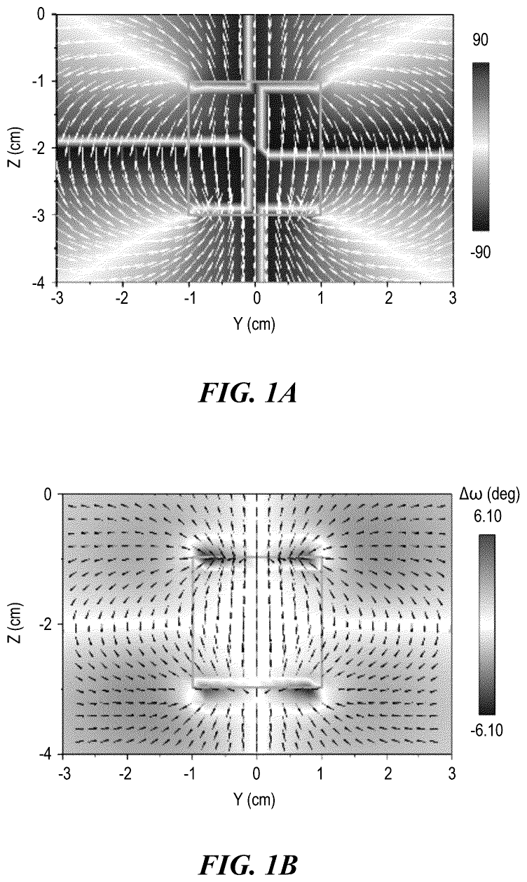

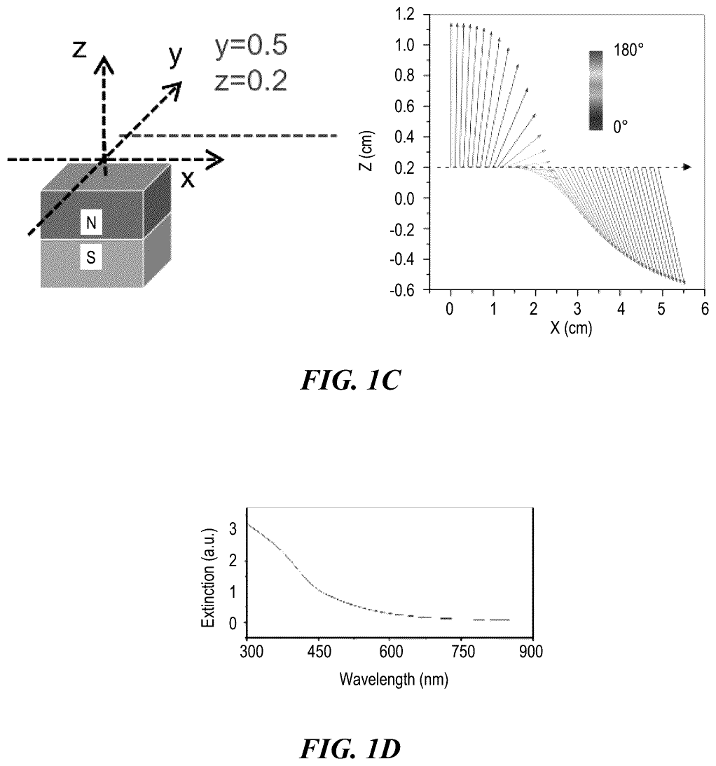

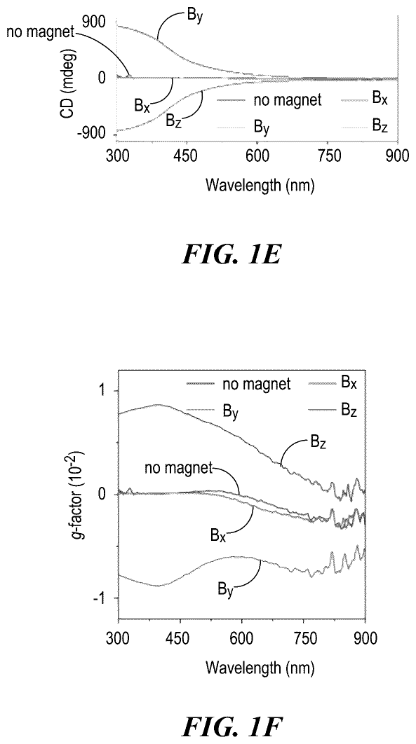

A method of assembling a chiral structure using the magnetic field and field distribution of a cube-shaped permanent magnet, with the north pole of the magnet pointing upward is illustrated and discussed herein. The calculated azimuth of the local magnetic field (mapped in FIG. 1A) undergoes gradual changes in the field direction in each quadrant. A differential magnetic field was calculated by subtracting magnetic field vectors in two chosen y-z cross sections. As shown in FIG. 1B, the resulting local field rotation is indicated by the black arrows, and the magnitude is color-mapped, with the rotation angle (Δω) being defined as the difference between the azimuth of the magnetic fields in the two cross sections. The differential field forms a quadrupole, with two left-handed (positive Δω in red domains) and right-handed (negative Δω in blue domains) magnetic field domains. FIG. 1C further delineates the rotation of local fields along a chosen pathway, demonstrating the helical magnetic field distribution.

An analytical model was developed to understand the assembly of magnetic nanorods in a chiral field that could predict magnetic nanorods alignment along the local field to form chiral superstructures (FIG. 1D). For small magnetic nanorods (107.6±5.2 nm in length and 13.0±1.7 nm in diameter) there are no obvious CD signals in rod dispersion without a magnetic field or in a magnetic field along the x-axis (Bx) but changing the field direction from the x-axis to y- and z-axis created CD responses, as shown in FIGS. 1E and 1F. Positive and negative CD peaks of similar intensity were observed for the y- (By) and z-field (Bz), respectively, which suggested chiral superstructures with opposite handedness. The CD responses were then measured in an aqueous solution of glycerol (n=1.475) with an increasing volume ratio from 0 to 100%. The increase in effective refractive index (n) of the solution induced consistent CD-intensity decrease under the same magnetic fields. The nanorods' CD signal weakened but did not disappear as the solution refractive index approached that of the silicon dioxide (SiO₂) layers (n=1.475±0.005). This refractive index-matching experiment demonstrates that both the scattering and absorption of the nanorods contribute to the overall CD responses. Based on this analytical model, an optical anisotropic factor (g-factor) of ˜0.01 at 400 nm was calculated (FIG. 1G).

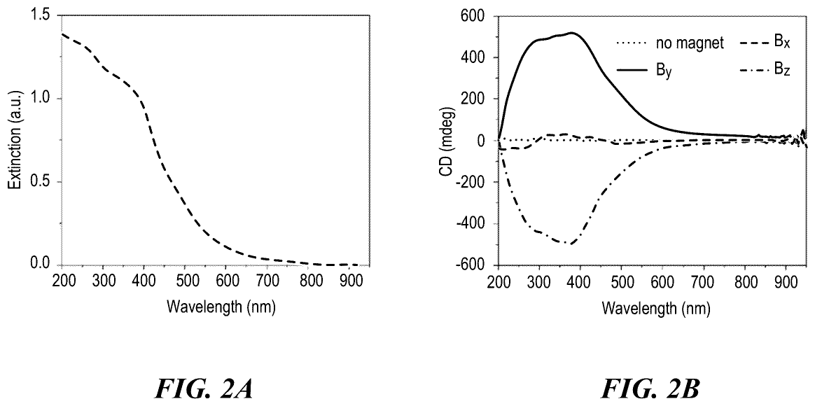

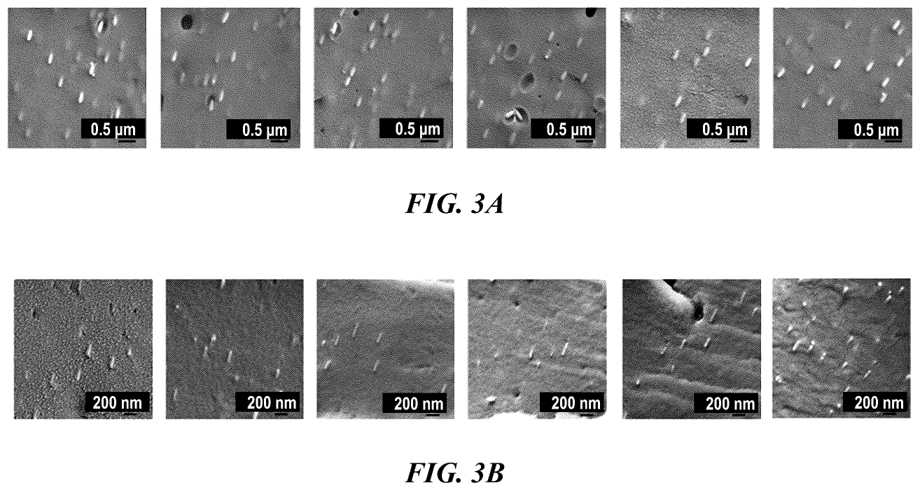

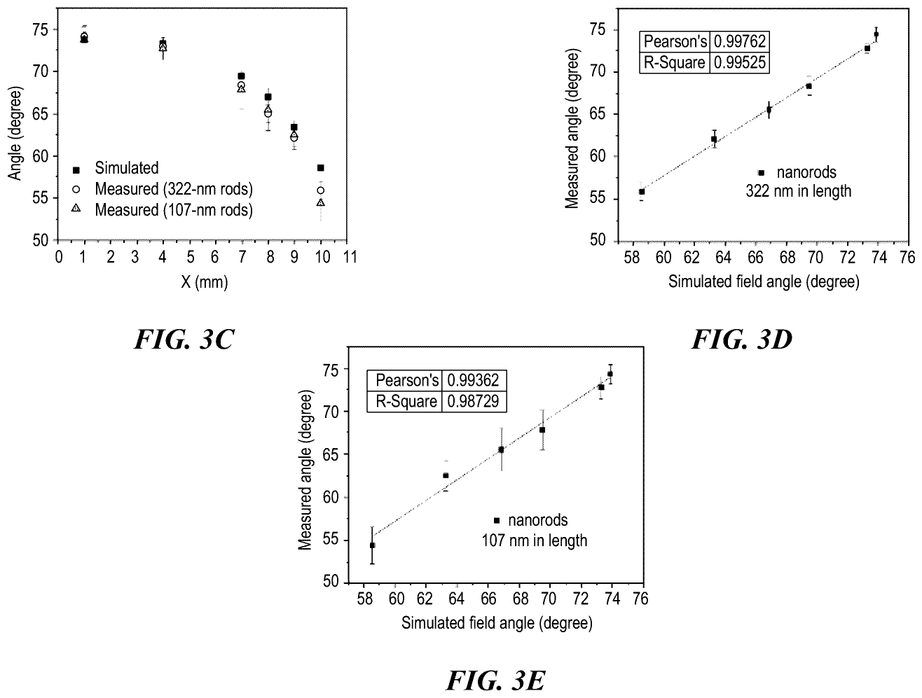

To verify the formation of chiral superstructures, cyanine 3-doped Fe₃O₄@SiO₂ core-shell nanorods (322.2±16.5 nm in length, 70.2±4.7 nm in diameter, and 50.3±1.5 nm in silica thickness) were used as magnetic building blocks and fixed in a polymer by photocuring under a uniform magnetic field. Linear chains were formed because of magnetic dipole-dipole interactions and were parallel to the uniform field with a standard deviation of 0.36° to minimize the demagnetizing fields. If a gradient field of a permanent magnet (cube shape, 12 mm in edge length) was used, the chain alignment within one yz plane and the chain rotation between different yz planes were determined by the local magnetic fields and field rotation, respectively. Thus, the chiral superstructures made of large nanorods (322.2±15.6 nm, 70.2±4.7 nm in diameter) show similar CD responses to magnetic fields, as shown in FIGS. 2A and 2B. Additionally, the chain alignment was characterized in 10 sequential yz layers from x=1 to 10 mm and in five layers along the y axis using optical and electron microscopy, confirming the chain rotation into chiral superstructures as driven by the quadrupole chiral field (FIGS. 3A-3E).

### Magnetic Assembly and Active Tuning of Plasmonic Chiral Superstructures

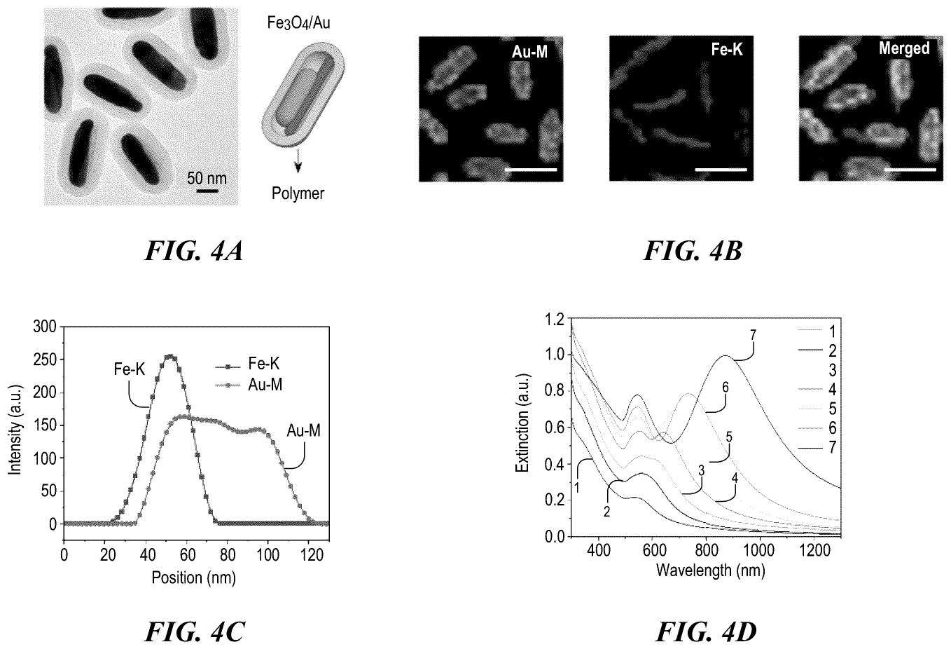

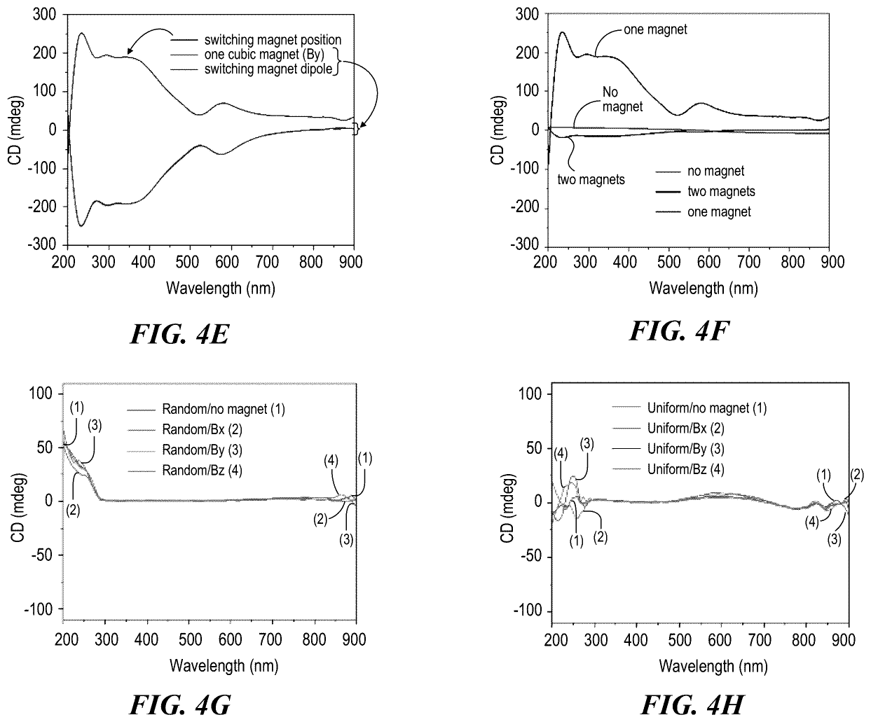

To systematically study the CD dependence on magnetic fields over a wide spectral range, Fe₃O₄/Au hybrid nanorods were introduced as building blocks by taking advantage of the localized surface plasmon resonance (LSPR) of Au nanorods and the magnetic responses of Fe₃O₄ nanorods. The Au nanorods were synthesized using a space-confined growth method and had a length of 156.6±15.2 nm and a diameter of 48.9±4.7 nm. Fe₃O₄@SiO₂ nanorods were introduced (107.6±5.2 nm in length, 13.0±1.7 nm in diameter, 5.0±0.5 nm in silica thickness) as initial templates, followed by Au seed attachment (˜ 2.0 nm in diameter). During polymer coating, the SiO₂ shells were etched away, and defined gaps were formed between the Fe₃O₄ nanorods and polymer shells. Seeded growth was performed inside the gaps to prepare the hybrid nanorods. Each of these Fe₃O₄/Au hybrid nanorods comprised one Au nanorod and one Fe₃O₄ nanorod in a parallel configuration, as shown in the transmission electron microscopy (TEM) images (FIG. 4A) and elemental mapping (FIGS. 4B and 4C). Due to the confinement of the polymer shells, radial growth was limited, and preferable longitudinal growth produced the Au nanorods. This growth mode allows easy tuning of the nanorod length and shifts the LSPR of the Au nanorods from 560 nm to 880 nm (FIG. 4D). The parallel alignment of the hybrid nanorods allowed the Au nanorods to assemble into chiral superstructures under a chiral magnetic field and produce CD responses. Switching the magnet dipole did not alter the CD profile, but changing the magnet position to the opposite side of the sample produced a CD spectrum with an opposite sign, as shown in FIG. 4E.

Applying two identical magnets in their attraction configuration generated a parallel magnetic field with a reduced field gradient between the two magnets and reduced the CD signals (FIG. 4F). The disappearance of CD signals confirmed that linear superstructures assembled in a uniform magnetic field could not produce CD signals in our experimental conditions. Additionally, the hybrid nanorods were fixed under the absence and presence of uniform and chiral magnetic fields using a photocuring polymerization method, which produced random, linear, and chiral structures, respectively. Although films containing random and linear structures were not optically active, the film with chiral superstructures had CD signals. None of the three structures showed evident responses to a magnet once fixed in polymer films (FIGS. 4G-4I). These experiments suggested that the observed CD responses in a single permanent magnet were not induced by extrinsic chirality, a CD property of achiral superstructures, or by magnetic circular dichroism.

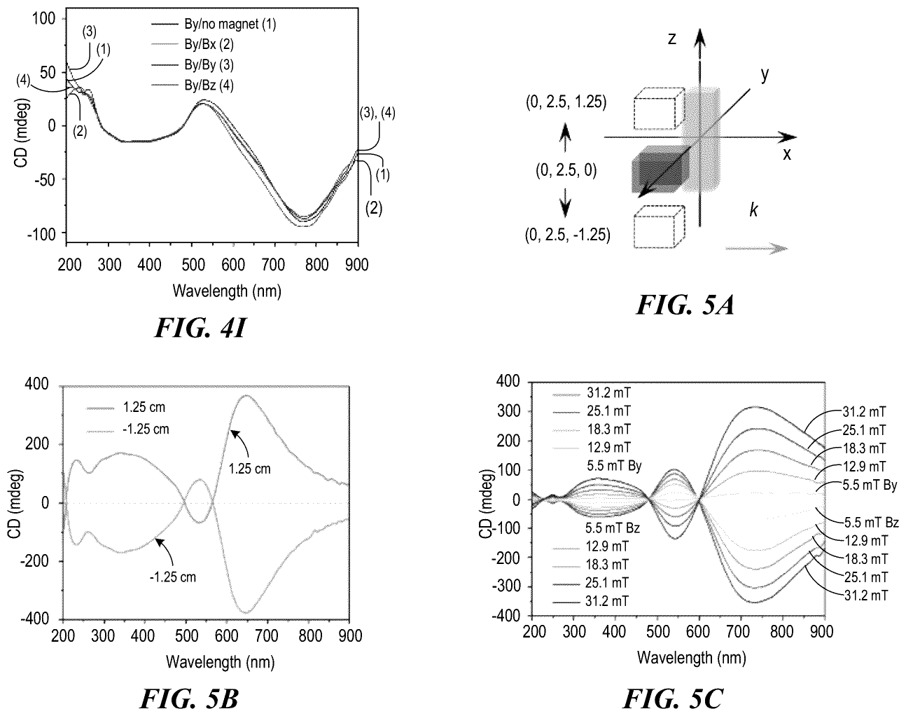

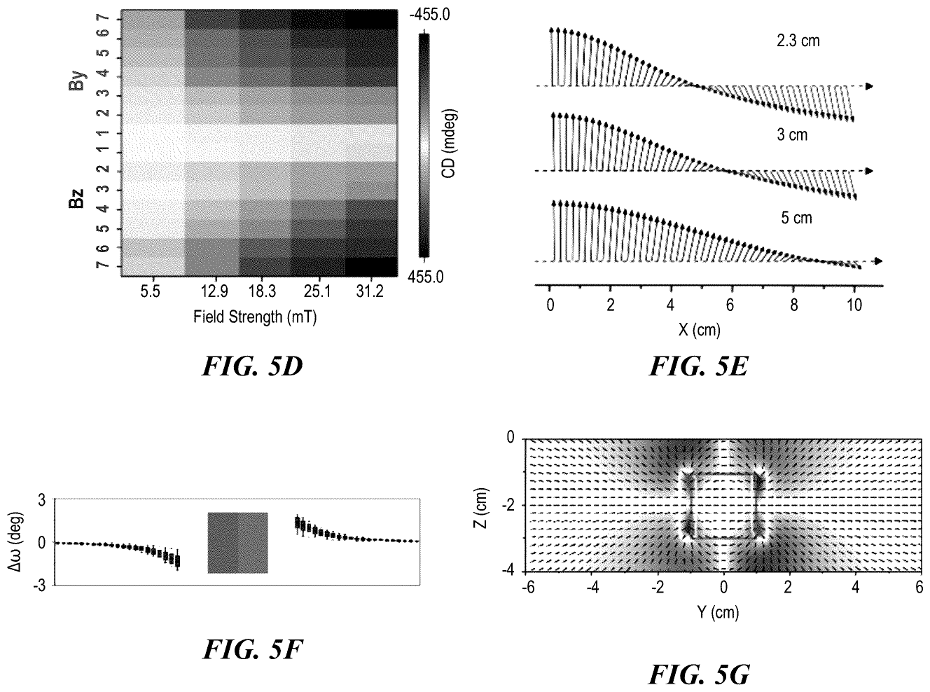

The CD spectra of Au nanorods was measured while changing the position of the magnet vertically (FIG. 5A). The CD signal declined gradually after the magnet was moved from −1.25 cm to 0 cm along the z-axis (vertical direction), and the spectra changed the sign across 0 cm (FIG. 5B) in response to the field chirality changes. The dependence of CD signals on magnet position was similar when the magnet dipole was along the z-axis. Changing the samples' position relative to the magnet was equivalent but induced CD intensity decrease if the sample-magnet separation increased up to 3.0 cm along the x-axis. The CD spectra of Au nanorods were then measured by decreasing field strength from 31.2 mT to 25.1 mT, 18.3 mT, 12.9 mT, and 5.5 mT, which corresponded to the magnet being 2.3 cm, 2.5 cm, 3 cm, 4 cm, and 5 cm away from the nanorod dispersion. A consistent decrease in CD intensity was observed for Au nanorods with different LSPR positions and for left- and right-handed chiral superstructures (FIGS. 5C and 5D), which corresponded to the decrease in field rotation rate as the magnet was moved away the sample (FIG. 5E). Detailed field analysis in FIGS. 5F-5I indicated that the rotation angle (40) decreased consistently in the four chiral domains for increasing magnet-sample separation. The sample in the first quadrant was in a left-handed field in the By field (FIGS. 5F and 5G), which caused the negative signals in CD spectra. In contrast, in the Bz field, the chiral field in the first quadrant produced positive CD signals (FIGS. 5H and 5I). The extinction and CD peak intensity of the hybrid nanorods at fixed magnet and sample positions were linearly proportional to Au concentration, which was consistent with Beer's law and molar ellipticity in CD.

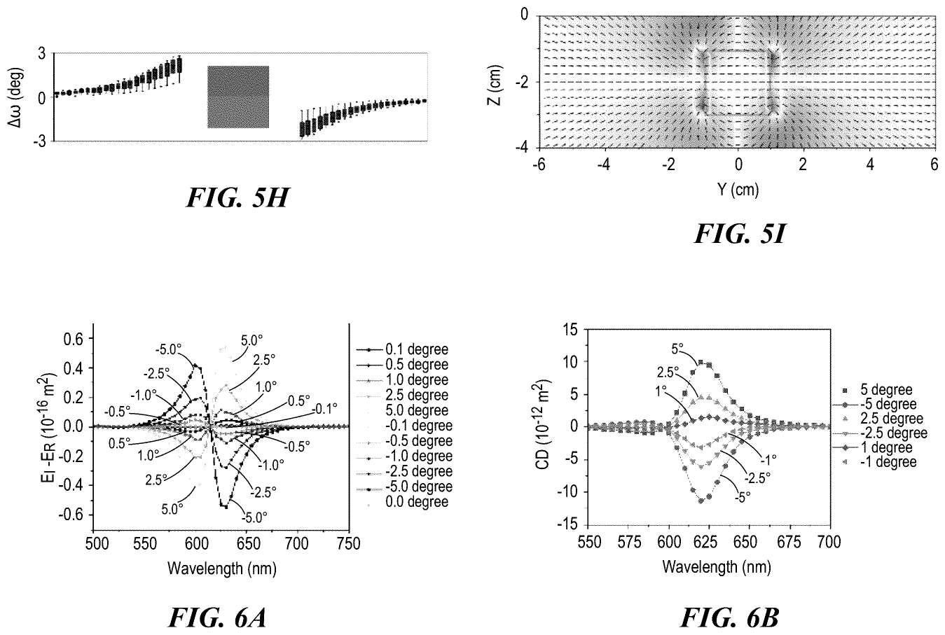

To verify the chiroptical properties, the chiral superstructures were modeled, and their CD spectra were calculated using a finite element method. The simulated spectrum in FIG. 6A demonstrated CD responses of Au nanorods with large separations. Considering the lack of nanorod positional order in experiments, complex models were further developed to resolve the structures in FIGS. 3A and 3B. The models contained nanorods with random positions but constant rotation in different planes, resembling the nanorod alignment in different cross sections in the SEM images. The simulated CD spectra showed rotation angle-dependent CD responses (FIGS. 6B and 6C), which explains the decrease of CD intensity with the rotation angles of magnetic fields. Similar dependence was also observed in nanorods of increasing aspect ratios.

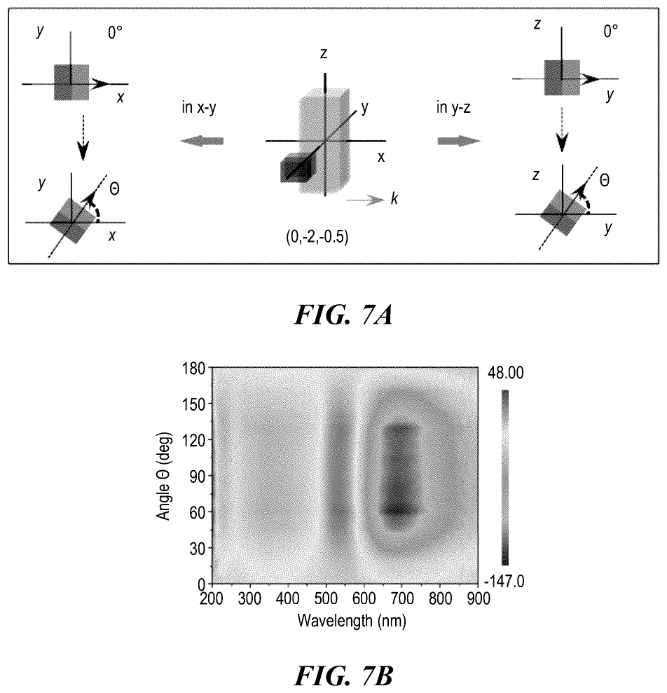

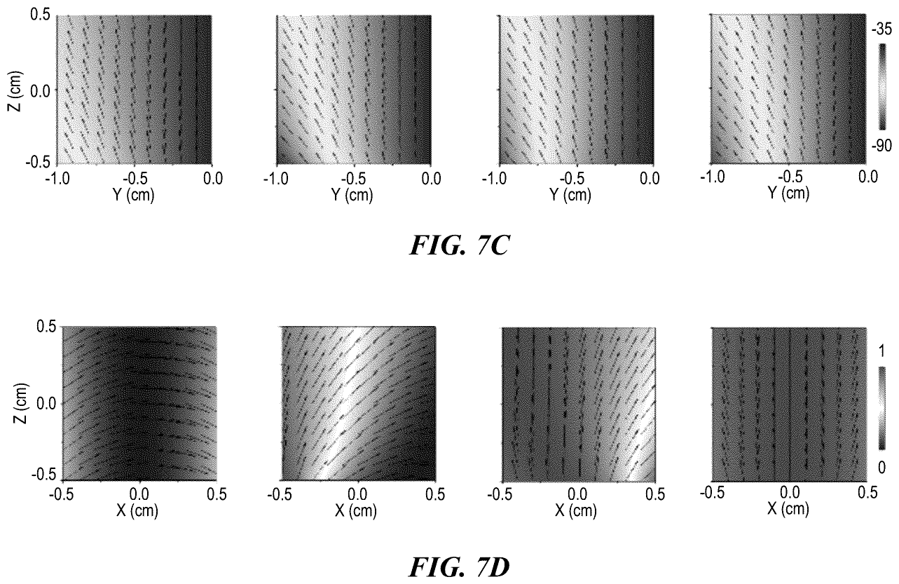

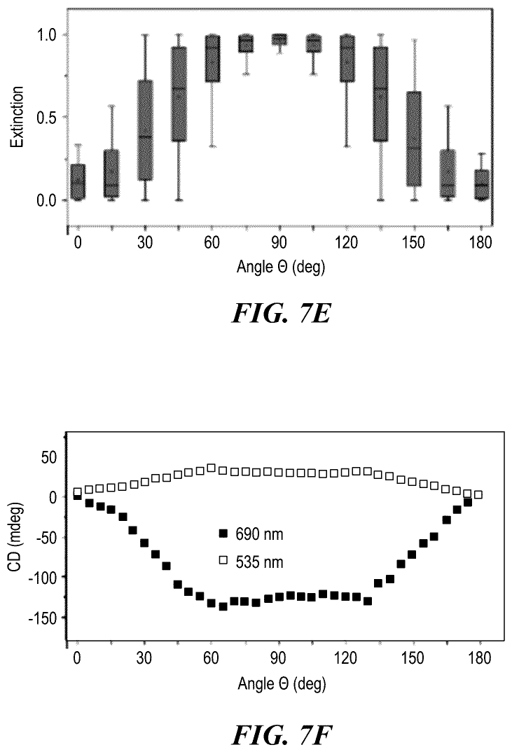

Changing the directions of the magnetic field produced more complex CD responses. The rotation of the magnet within the x-y and y-z planes can be used to explain the involved mechanisms (FIG. 7A). The alignment of the magnetic dipole of the magnet relative to the axes was defined by the azimuth angle Θ. The CD spectra showed intensity changes when Θ increased to 180° in the x-y plane (FIG. 7B), which increased to a saturated value and decreased again. Given the magnet was rotated in the x-y plane, the local magnetic fields and the field distribution were analyzed for different Θ values. Because the incident light was along the x-axis, the magnetic fields within the measured domains in the y-z and x-z planes were further plotted in FIGS. 7C and 7D, respectively. Slight changes in field direction and field distribution within the y-z plane were observed for different magnet orientations (FIG. 7C). In the x-y planes, however, the field distribution exhibited dramatic changes when Θ increased to 90°, which led to excitation of longitudinal mode with gradually increased strength (FIG. 7D). For incident light along x-axis, the plasmonic excitation of Au nanorods was determined and could be predicted by the nanorod alignment, light incidence, and light polarization. Due to the changes in magnetic field direction and distribution, there was an associated change in the LSPR excitation of the Au nanorods when Θ increased to 90°. At 0°, the field was nearly parallel to the x-axis, and the resulting parallel alignment of nanorods to the incident light suppressed the longitudinal mode. At 90°, the magnetic field being nearly parallel to the z-axis led to the excitation of the longitudinal mode. The longitudinal extinction of the Au nanorods can be predicted through the equation sin 2(ϕ) where ϕ is the angle between the local field direction and the light incident direction. The extinction graph in FIG. 7E showed a symmetric trend, with maximum extinction between 60° and 120°. Comparison of the predicted longitudinal extinction to the CD intensity measured at different Θ (FIG. 7F) suggested that CD intensity would depend on the magnet azimuth angle and that the CD responses of the assembled superstructures would be determined by the longitudinal extinction changes when the magnet azimuth increased within the x-y plane.

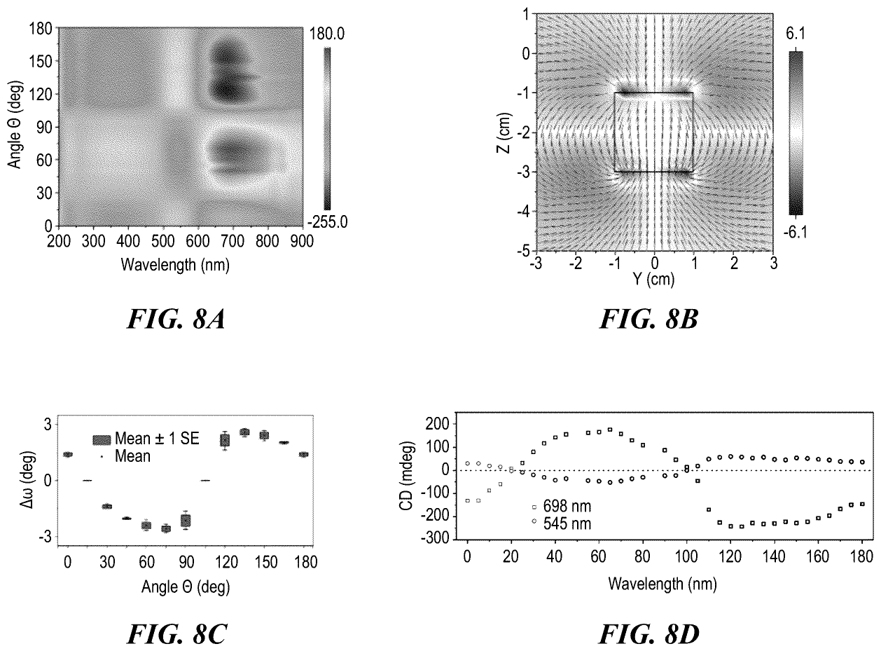

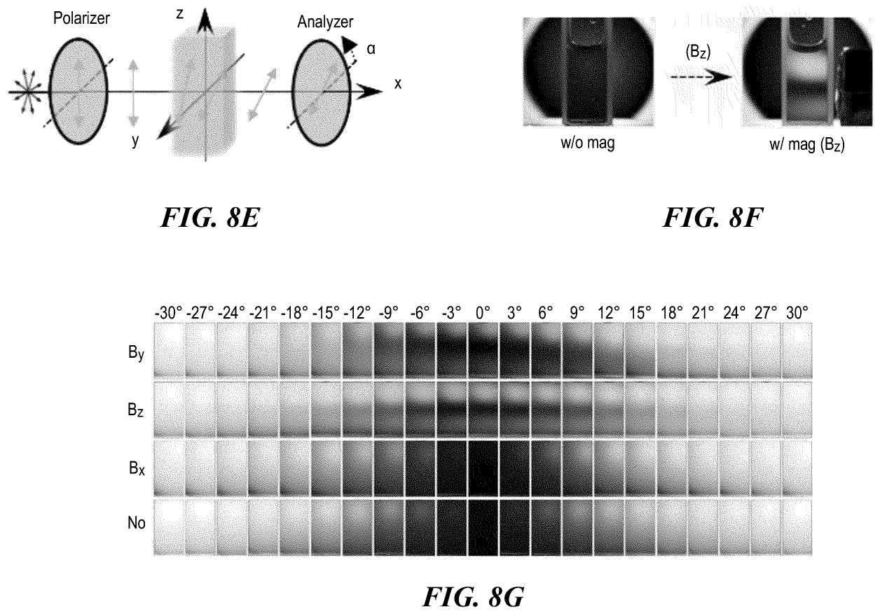

Changing the magnet azimuth in the y-z plane led to a different CD response, with a mechanism associated with field chirality changes. The CD peaks at 545 nm and 698 nm simultaneously switch their signs at about 20° and 110° during the measurement (as depicted in the color map in FIG. 8A), which suggested that the handedness of the assembled superstructures changed. To verify this hypothesis, the analytical model was used to directly map the local field rotation direction, chirality, and handedness. At Θ=0°, the sample was 2 cm away from the magnet center, with an upward offset of 0.5 cm, which led to an azimuth of ˜14° relative to the magnet center. Understanding the CD spectrum at Θ=0° required access to field properties at this specific sample location in the y-z plane. The CD changes in response to magnet rotation were studied by analyzing the local field properties in different azimuth angles. In FIG. 8B, the plots of field distribution and field chirality within the y-z plane showed a similar quadrupole field chirality. The normalized field vectors at x=−0.2 cm and x=−0.8 cm were superimposed in FIG. 8B to illustrate local field rotation. The field rotation angles are shown in FIG. 8C, which corresponds to the field changes during experimental measurement. The rotation angle (Δω) was initially positive but changed its sign at Θ=15° and 105°, consistent with the experimental chirality transition angles plotted in FIG. 8D. The Pearson correlation coefficients between the field rotation angles and CD intensity at 698 nm and 545 nm are −0.989 and 0.987, respectively. The strong negative and positive correlation indicates that the field chirality changes could explain the dependence of the superstructure handedness and CD spectra on magnet rotation in the y-z plane.

### Optical Rotary Dispersion (ORD)

The optical rotatory dispersion (ORD), which measures the polarization rotation of a linearly polarized light, was also studied. Left- and right-handed circularly polarized light interacts differently with chiral structures and travels at a different speed inside them. Because linearly polarized light comprises two circularly polarized light beams with the same magnitude but opposite handedness, these two highly correlated beams develop a phase difference, leading to the polarization rotation of the incident beam (FIG. 8E). The ORD effect was tested by applying an analyzer to the incident beam and observing the color changes. Only light of a specific wavelength can pass through the analyzer at a polarization angle (α) if the material is optically active. Experimentally, α is defined as the angle between the analyzer polarization direction and the horizontal baseline, and the polarization of the polarizer is fixed along the vertical direction.

Digital images of a nanorod dispersion are shown in FIG. 8F before (left image) and after (right image) application of a z-directional magnetic field at α=3°. The original dispersion appeared dark without noticeable colors because only minimal light could transmit through the analyzer. Under a z-directional magnetic field, the top domain turned yellow and the bottom red, demonstrating the formation of chiral superstructures with opposite handedness in these two domains, consistent with the predicted field chirality in the first and fourth quadrants of the magnet. This ORD effect was determined by superstructure handedness and the angle α. Under a z-directional magnetic field, similar two-color domains were observed when α increased from −30° to 30° (FIG. 8G), with red-orange-yellow-green changes in the top domain and opposite color changes in the bottom domain. Changing the magnetic field to the y-axis led to color switching between the two domains, corresponding to a field chirality transition. A nanorod dispersion under the absence and presence of the x-directional magnetic field only exhibited contrast changes at different a because of the negligible CD responses at these two conditions.

Generalizing the all-Scale Chiral Assembly: From Nanostructures to Molecules

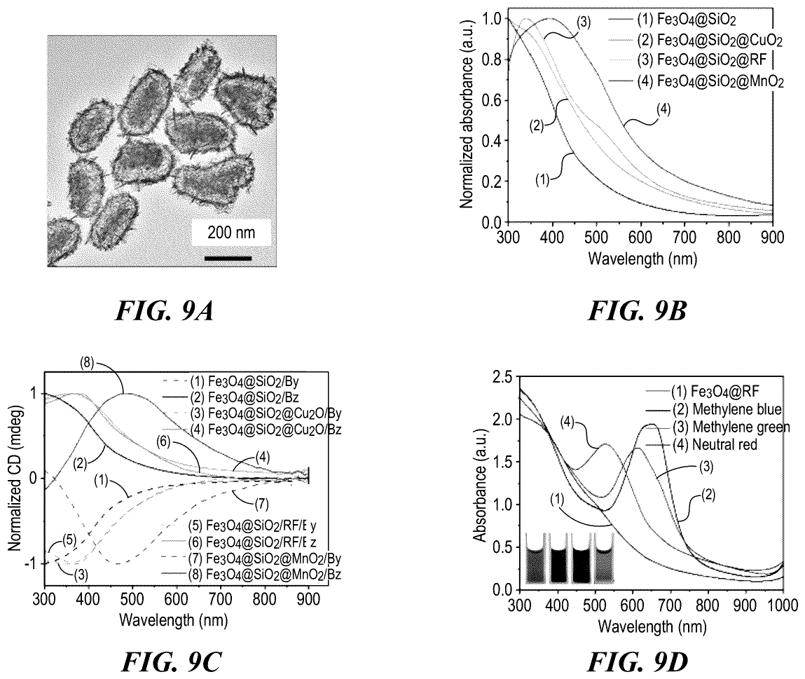

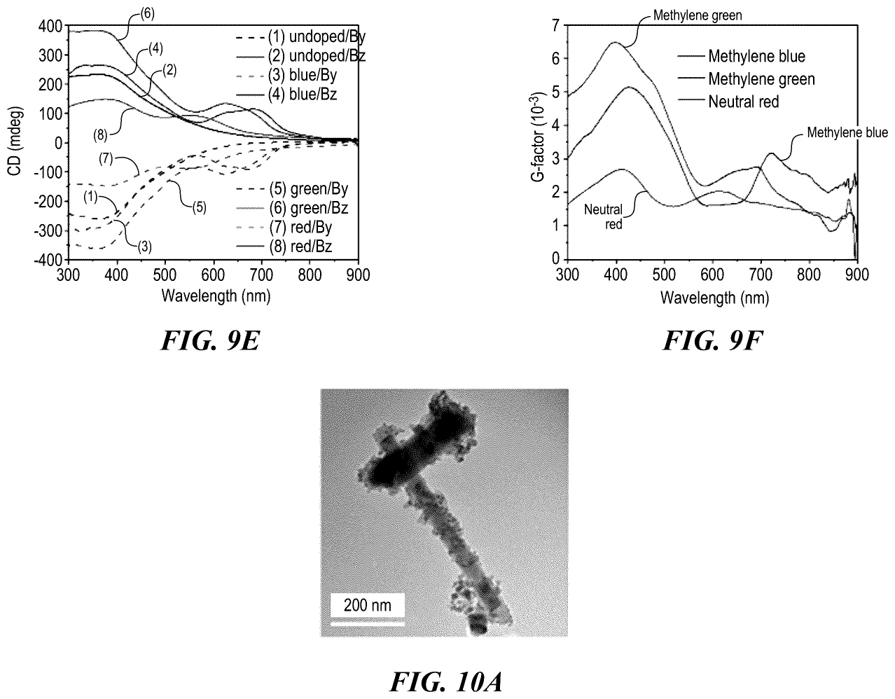

The chirality formed by nanoscale magnetic assembly can be transferred to guest materials, such as, for example, organic molecules, polymers, oxides, and semiconductors. These guest materials may be introduced to the magnetic nanorods through surface coating and doping methods, which have the advantages of wide material accessibility and easy further processing. Starting with Fe₃O₄@SiO₂ nanorods with a length of 107.6±5.2 nm, a diameter of 13.0±1.7 nm, and silica thickness of 5.0±0.5 nm, their surface was coated with Cu₂O nanoparticles and resorcinol-formaldehyde (RF), with the latter being converted into MnO₂ by reacting with KMnO₄. The resulting Fe₃O₄@SiO₂@MnO₂ nanorods (FIG. 9A) underwent oxidation-induced volume expansion creating nanogaps between porous MnO₂ nanoshells and Fe₃O₄@SiO₂ cores. The extinction spectra of these samples us shown in FIG. 9B, which depicts the broad extinction of Fe₃O₄@SiO₂ and Fe₃O₄@SiO₂@Cu₂O nanorods and extinction peaks of Fe₃O₄@SiO₂@RF and Fe₃O₄@SiO₂@MnO₂ nanorods. These four samples showed evident CD activities under magnetic fields that can also be tuned by changing the field directions (FIG. 9C). The CD peak positions being near their extinction peak positions indicates that the chirality in the superstructures transferred from the host nanorods to the guest molecules. In addition, changing the field direction from the y-axis to the z-axis changed the chiral superstructures from left-handed to right-handed symmetry.

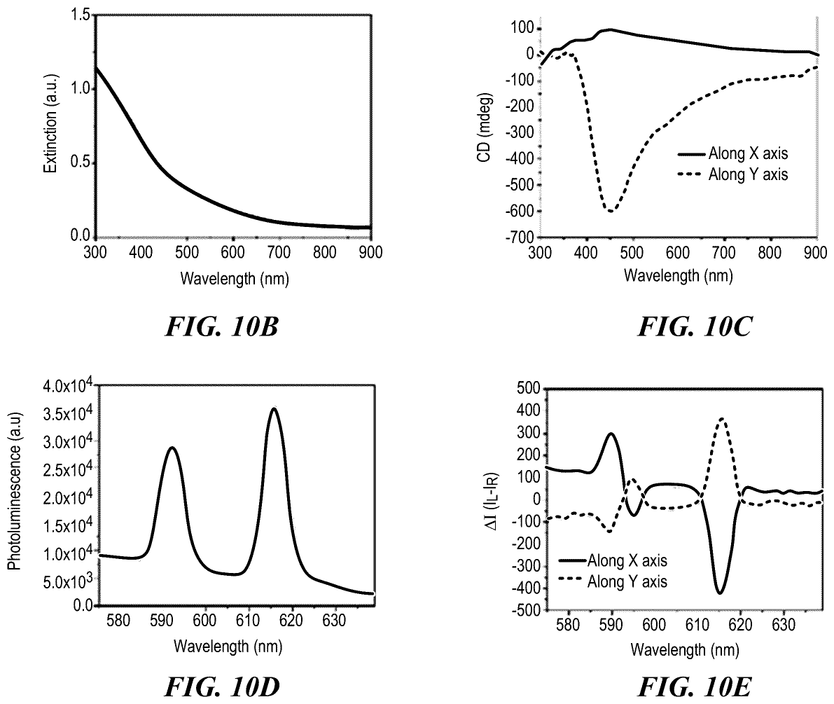

Transfer of chirality to small molecules was demonstrated by doping organic dyes into RF polymeric shells through electrostatic interactions. Three dyes, including methylene blue, methylene green, and neutral red, are chosen. These dyes develop positive charges after dissociation of chloride anions in water and can be doped into porous RF shells by mixing with the nanorods at room temperature. FIG. 9D show that the dyed solutions appeared blue, green, and red after removing the excess molecules, with extinction spectra exhibiting distinct peaks after successful doping. Using the green dye-doped nanorods as an example, the CD responses under different field directions were analyzed, with negligible CD signals under no and x-directional magnets and opposite CD peaks in y- and z-directional magnetic fields. The CD spectra of nanorods doped with all three dyes (FIG. 9E) showed peaks at their characteristic wavelengths. The observation is consistent with that of plasmonic nanorods and demonstrated the formation of chiral superstructures and the successful transfer of chirality from the nanoscale to molecular levels. The g-factor calculated in FIG. 9F has a maximum of ˜0.003 for methylene blue-doped nanorods, a value comparable to that of classic chiral molecules and magnetically assembled chiral superstructures of inorganic molecules, polymers, and semiconductors. Further, the magnetic assembly strategy could be extended to the assembly of fluorophores for generating circularly polarized luminescence. When europium-doped NaYF₄ nanorods were decorated with Fe₃O₄ nanoparticles, the fluorescent nanorods could be assembled into chiral superstructures and exhibited circularly polarized luminescence as shown in FIGS. 10A-E.

The consistent rotation of the local field vectors of the cubic permanent magnet forms the quadrupole field chirality with alternating left-handed and right-handed magnetic fields in the four quadrants. Such chiral magnetic fields induce the assembly of magnetic nanorods into chiral superstructures, with handedness and chirality determined by the local features of the magnetic fields. This strategy allows remote, reversible, and instantaneous assembly of chiral superstructures from nanostructures of various chemical compounds (plasmonic materials, polymers, oxides, metals, semiconductors, fluorescent nanostructures, and molecular moieties) and active tuning of their CD responses in a broad range of spectra and circularly polarized luminescence, as long as they can be properly bound to the magnetic nanorods. Fixing the chirality of these chemical compounds at all scales is possible by embedding the formed super-structures in polymer substrates, which could be realized by applying an external magnetic field during polymerization. This simple strategy makes the chiral superstructures nonvolatile without external magnetic fields and highly accessible for portable chiroptical devices.

### Magnetic Assembly of Magnetic/Plasmonic Nanospheres

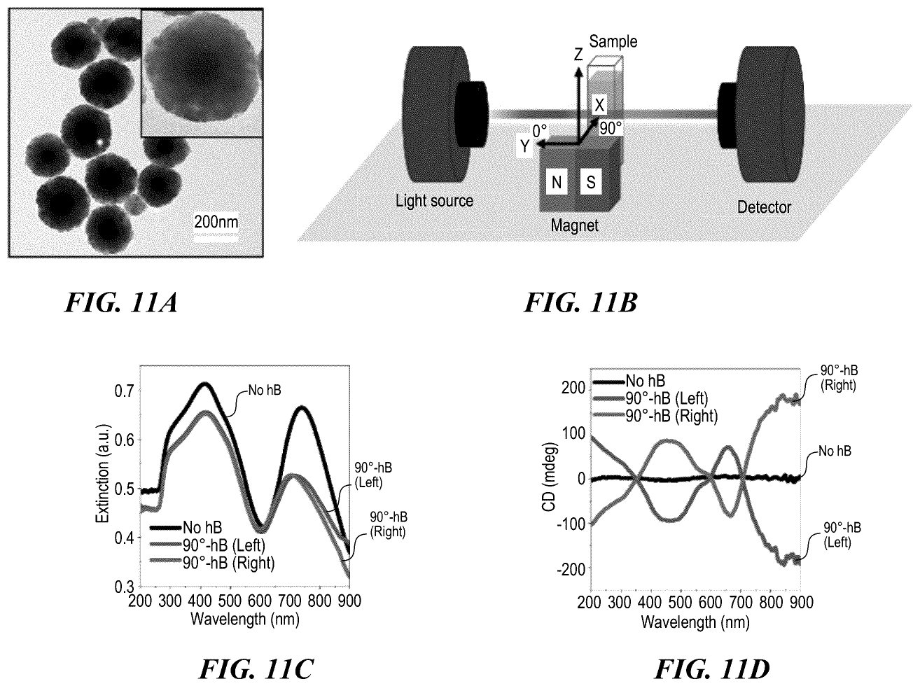

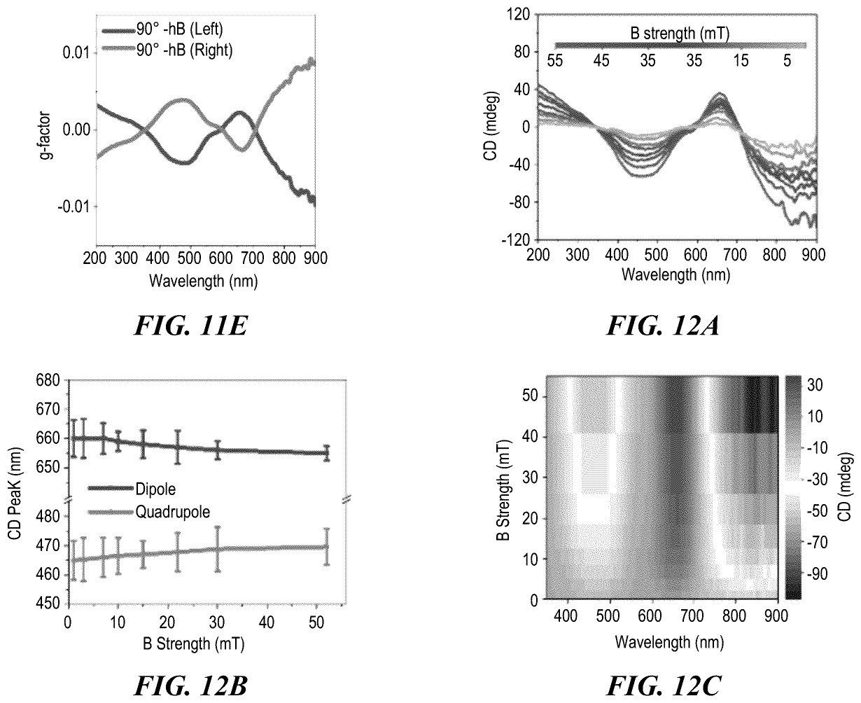

The chirality of the magnetic field can be used to assemble magnetic nanospheres into chiral superstructures. FIG. 11A shows the TEM image of the magneto-plasmonic Ag@Fe₃O₄ core-shell nanoparticles with Ag size around 80 nm and Fe₃O₄ shell thickness around 75 nm. They were used as building blocks and assembled into plasmonic chiral nanostructures under the hB. FIG. 11B shows the experiment setup of the extinction and CD spectra under the hB. The cubic magnet was placed beside the sample solution in a cuvette and the magnetic field direction was controlled by rotating the magnet along the Z-axis within the XY plane. The magnetic field was defined as 0°−hB and 90°−hB when the north pole of the magnet was towards the Y- and X-axis, respectively. FIG. 11C shows the extinction spectra of the Ag@Fe₃O₄ nanoparticle solution without and with left- and right-handed 90°−hB. The dipole and quadrupole peak blue-shifted from 760 to 720 nm and 424 to 418 nm after applying 90°−hB due to the far field plasmonic coupling. FIG. 11D shows the CD spectra of the nanoparticle solution without and with left- and right-handed 90°−hB. The Ag@Fe₃O₄ nanoparticles themselves were achiral and showed no CD signal without hB, however, they showed an obvious CD signal with two bisignate line shapes from dipole and quadrupole plasmonic peaks under 90°−hB. Due to the limited wavelength scale of the CD detector, the CD spectrum was measured in the range of 200 to 900 nm. The peak around 666 nm is from the dipole plasmonic peak and the peak around 460 nm is from the quadrupole plasmonic peak. The handedness of the assembled chiral nanostructures can be easily reversed by moving the magnet to expose the sample from left- to right-handed 90°−hB without changing the direction and position of the magnet. As shown in FIG. 11D, the CD signal was reversed but with the same magnitude as the hB switching from left- to right-handedness. FIG. 11E shows the corresponding g-factor of the nanoparticle solution, showing a maximum g-factor value of around ±0.01, which is much higher than the most previously reported values, indicating the strong chirality of the plasmonic chiral nanostructures.

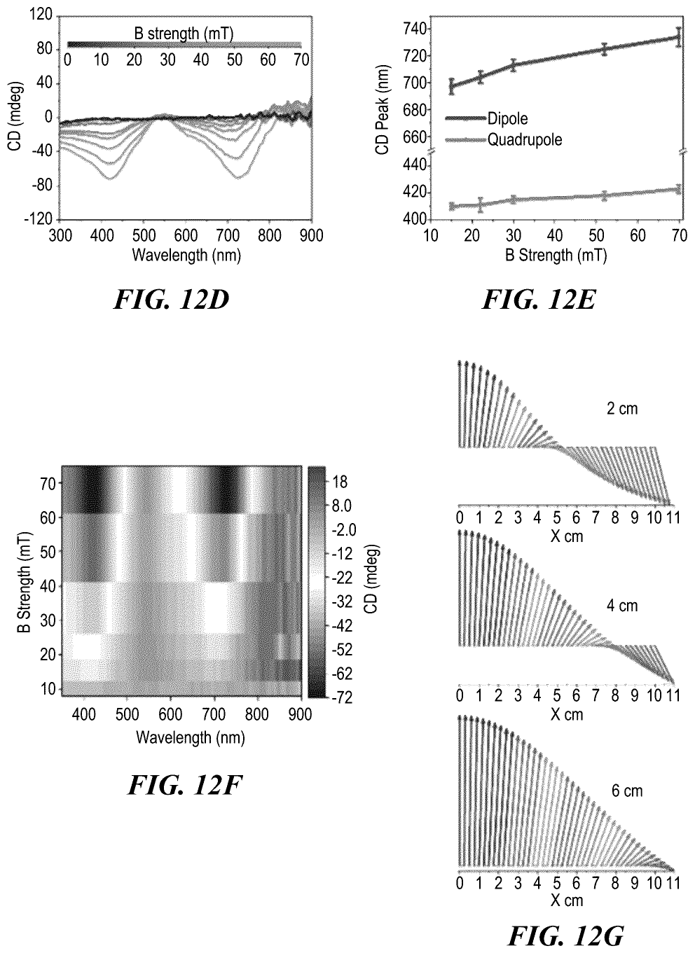

Both CD intensity and spectral position can be dynamically tuned by varying the magnetic field strength, thereby modulating the plasmonic coupling. The magnetic field strength was controlled by the distance between the sample and the cubic magnet. The separation distance between neighboring nanoparticles was determined by the electrostatic repulsion force and magnetic attraction force. The increase of the magnetic field strength decreases the separation distance, enhancing the plasmonic coupling. As shown in FIGS. 12A-12C, the CD dipole peak was gradually blue-shifted, while the CD quadrupole peak was slightly red-shifted. Additionally, the intensity of the dipole and quadrupole peaks was greatly enhanced as the 90°−hB strength increased from 1 mT to 52 mT. Under 0°−hB, both CD dipole and quadrupole peaks red-shifted (FIGS. 12D and 12E), and the intensity of both peaks was dramatically enhanced (FIG. 12F) as the magnetic field strength increased from 3 mT to 70 mT. As is known in the art, a CD spectrum measures the difference between the extinction of left- and right-hand circularly polarized light. Thus, the extinction peak shift directly contributes to the CD peak shift, showing similar trends. Increasing magnetic field strength enhances the plasmonic coupling, which, in turn, induces both extinction and CD peak shifts. Besides, the spatial arrangement of the nanoparticle assembly depends on the distance from the magnet. FIG. 12G shows the simulation results of the magnetic field vector rotation along the X-axis under different distances along the Y-axis from the cubic magnet. The rotation angle along the X-axis within a 10 cm fixed distance was compared, which showed the gradual decrease of the rotation angle with the increasing distance from 2 cm to 6 cm, indicating the increase of the pitch and the decrease of the chirality. Both enhanced plasmonic coupling and pitch decrease contributed to the CD spectral shifts and intensity enhancement under increasing magnetic field strength.

### Fixing Chiral Superstructures in Polymers for Color Switching

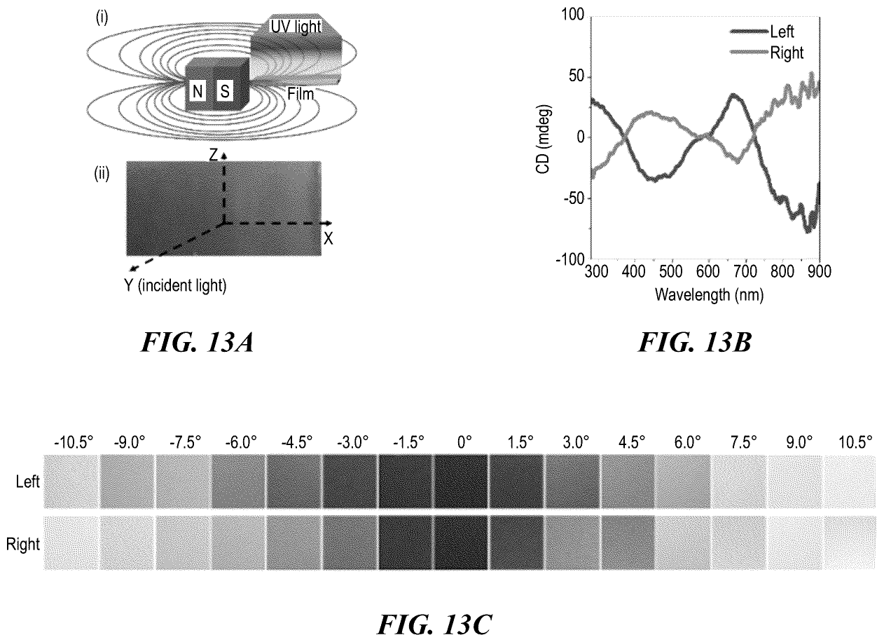

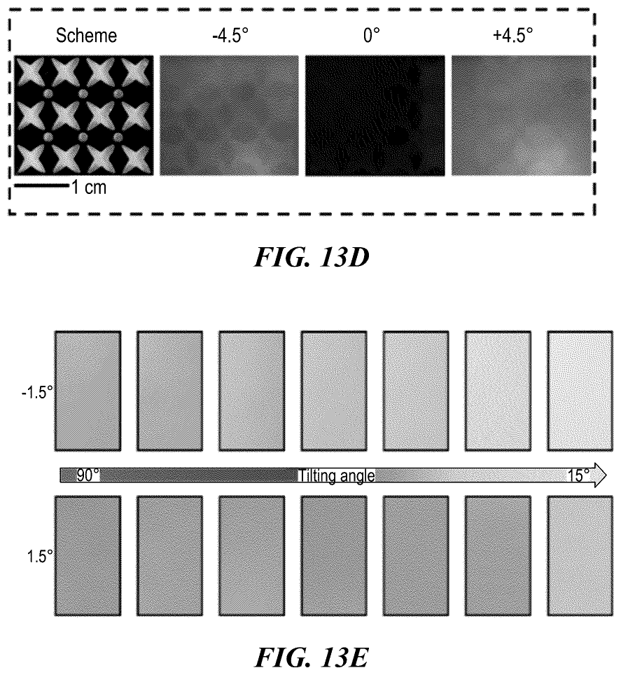

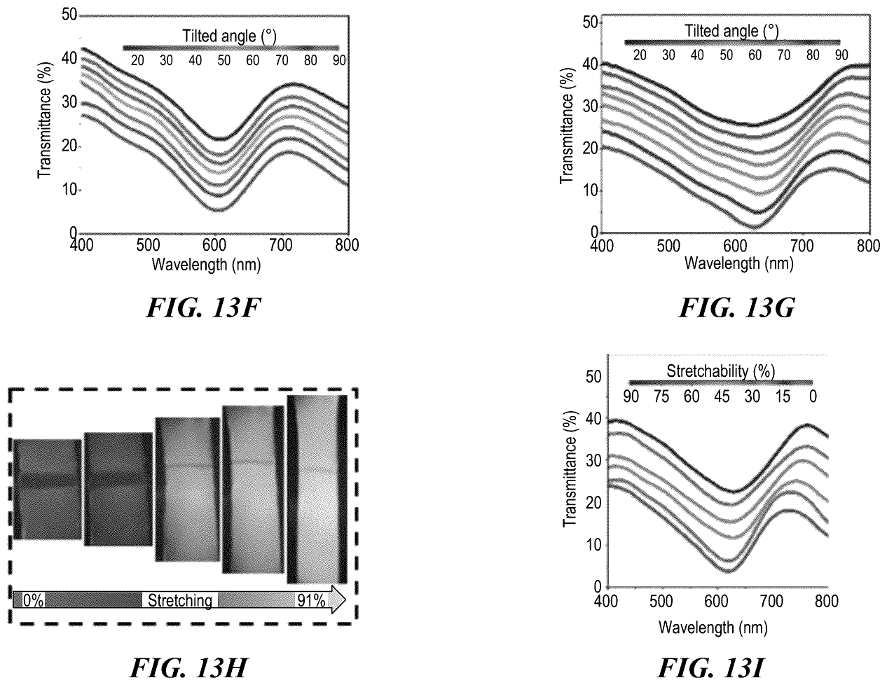

The plasmonic chiral superstructures can be fixed inside a polymer matrix by assembling the Ag@Fe₃O₄ nanoparticles within a photocurable polymer under hB, producing a plasmonic chiral film with tunable chiral optical properties (FIG. 13A (i)). A photo image of the chiral film with brownish color under ordinary light is shown in FIG. 13A (ii). The handedness of the film can be switched by controlling the direction of the film, showing left- or right-handedness as the film aligned along the X- or Z-axis under incident light propagated along Y-axis. FIG. 13B shows the CD spectra of the chiral film with switchable handedness when rotating the film from the X- to Z-axis. FIG. 13C shows the ORD images of the chiral film with tunable colors by varying β from −10.5° to 10.5°, showing flipped colors when the film orientation was changed from X-axis to Z-axis. Due to the easy control of the magnetic assembly, color-changing anticounterfeiting devices could be fabricated by fixing the chiral nanostructures with predesigned handedness in a polymer matrix. As shown in the scheme in FIG. 13D, the white areas contained left-handed chiral nanostructures, and the black areas contained right-handed chiral nanostructures. They showed no difference at β=0°, whereas at β=−4.5°, the white areas showed an orange color and the black areas showed a blue color. Further, the colors in the black and white regions were reversed at β=4.5°. By using different building blocks, chiral films with different patterns were fabricated and showed different switchable colors, indicating the potential for anticounterfeiting.

The plasmonic chiral film also showed angular-dependent colors from the ORD effect as modulating the angle between film and incident light. FIG. 13E shows the ORD images of the chiral film under β=±1.5° as the tilting angle between incident light and film varied from 90 to 15° within the YZ-plane. The color changed from pink to light blue at β=−1.5° and blue to purple at β=1.5°. FIGS. 13F and 13G show the corresponding transmission spectra of the chiral film at β=±1.5°. In both cases, the transmission peaks red-shifted as the tilting angle varied from 90 to 15°, which was consistent with the solution case under varying a from 90 to 0°. The extinction peak of the chiral film also red-shifted as the tilting angle decreased from 90 to 15° due to the angular-dependent plasmonic coupling. Furthermore, the optical properties of the chiral film can be mechanically tuned to develop stress sensors. FIG. 13H shows the chiral film with the middle area containing chiral nanostructures orientated along 45° relative to the long axis of the film and the rest of the area contained chiral nanostructures aligned along the long axis of the film, showing ORD colors of blue and pink respectively as β=−1.5° under no stress. While the colors of both regions gradually shifted to light blue as the stretchability increased from 0 to 92%, showing no detectable color difference between these two regions. FIG. 13I shows the redshift of the transmission peak of the pink region under stretching, which was consistent with the color changes. Both plasmonic and CD peaks red-shifted under stretching due to the increase of the separation distance between neighboring nanoparticles, decreasing the far-field plasmonic coupling. Additionally, the CD intensity gradually decreased with the increase of stretchability, which may be caused by the decrease of the nanoparticle density and disorder of the chiral nanostructures under stretching. The color of the chiral film can be dynamically controlled by mechanical stress, showing potential for applications in stress sensors, and anticounterfeiting.

### Preparation and Magnetic Assembly of Nanorods

Aqueous solutions of magnetic nanoparticles were dispersed in a cuvette during CD measurement. A permanent magnet was applied to the solution with a designated distance and magnet orientation. The position and orientation were carefully monitored during assembly to precisely control the magnitude and directions of the magnetic field, and schemes were provided in the main text and supplementary materials. The assembly and CD measurements were the same for different nanostructures. Polyacrylamide was introduced as transparent matrix to fix the superstructures. A precursor solution containing 250-mg AM, 14-mg BIS, 3-μL 2-Hydroxy-2-methylpropiophenone, and 1-mL water was prepared. Nanorods were dispersed in the precursor solution and sandwiched between a glass substrate and a cover glass. Ultraviolet light at 254 nm was used to initiate the polymerization while a magnetic field would be applied if needed. After irradiating ultraviolet light for one minute, the superstructures were fixed in the solid film for further characterization.

### Materials and Methods

### Materials

Chemicals were bought from commercial companies and used directly without any further purification. Polyacrylic acid (PAA, MW=1800), KMnO₄, CuCl₂, NaOH, Sodium dodecyl sulfate (SDS), iron chloride hexahydrate (FeCl₃·6H₂O), methylene blue dye, methylene green dye, neutral red dye, 3-aminopropyl-triethoxysilane (APTES, C₉H₂₃NO₃Si), tetraethyl orthosilicate (TEOS, C₈H₂₀O₄Si), polyvinylpyrrolidone (PVP, MW=10000), resorcinol (R), formaldehyde (F), L-Ascorbic acid (AA), Tetrakis(hydroxymethyl)phosphonium chloride (THPC), 2-Hydroxy-2-methylpropiophenone, and acetonitrile (ACN) are products of Sigma-Aldrich. Chloroauric (III) acid trihydrate (HAuCl₄·3H₂O), ethylene glycol (EG), and diethylene glycol (DEG) were purchased from Acros Organics. NH₃·H₂O, glycerol, and KI were purchased from Fisher Scientific. Ethanol (Proof 200) was purchased from Decon Labs. The cyanine 3 (Cy3) phosphoramidite was purchased from Glen Research. 2-Hydroxy-2-methylpropiophenone was used as a photoinitiator for polymerization and was purchased from Sigma-Aldrich. Acrylamide (AM) as the polyacrylamide precursor and N,N′-Methylenebisacrylamide (BIS) as cross-linking reagent were purchased from Fluka.

### Methods

Nanoparticle synthesis. The FeOOH, FeOOH@SiO₂, Fe₃O₄@SiO₂, Fe₃O₄@SiO₂@RF, and Fe₃O₄/Au hybrid nanorods were synthesized using methods reported in previous literature. Briefly, FeOOH nanorods (107.6±5.2 nm in length, 13.0±1.7 nm in diameter) were synthesized using a hydrothermal method. Silica (5.0±0.5 nm in thickness) was coated on the surface of FeOOH nanorods to form FeOOH@SiO₂ nanorods, which was reduced to Fe₃O₄@SiO₂ nanorods in DEG at 220° C. After the magnetic nanorods were modified by APTES, Au seeds with a diameter of ˜2 nm were attached to the Fe₃O₄@SiO₂ nanorods through electrostatic interactions. Then, resorcinol-formaldehyde (RF) resin was coated on the nanorods, during which the silica was etched away by the NH₃·H₂O, leaving hollow gaps between the Fe₃O₄ nanorods and the RF shells. Seeded growth was carried out to prepare Au nanorods in the gaps, leading to hybrid nanorods with Au nanorods and Fe₃O₄ nanorods parallel inside the RF shells. The size and peak positions of the Au nanorods were controlled by the concentration of HAuCl₄·3H₂O in the growth solution. The Fe₃O₄@SiO₂@Cu₂O nanorods were synthesized by coating Cu₂₀ layers on SiO₂ surfaces. In a standard procedure, 0.2 mL of CuCl₂ (0.1 M), 5 mL of SDS solution (0.06 M), 0.1 mL of Fe₃O₄@SiO₂ solution, and 0.25 mL of 2 M NaOH were added into 13 mL of MilliQ water. The solution was kept at room temperature with agitation for two hours, and the final products were washed with MilliQ water three times. The Fe₃O₄@SiO₂@Cu₂O nanorods were dispersed in MilliQ water for further characterization and measurement. The Fe₃O₄@SiO₂@MnO₂ nanorods were prepared by oxidizing Fe₃O₄@SiO₂@RF nanorods using KMnO₄ solution. To dope Cy3 to the magnetic nanorods, magnetic nanorods were dispersed in ACN with a concentration of ˜2 mg/mL. 20-μL of Cy3 solution in CAN was added to the nanorod dispersion, and the mixture was shaken at room temperature overnight. The excess Cy3 was removed by washing against ACN twice.

Magnetic assembly of chiral superstructures. Aqueous solutions of magnetic nanoparticles were dispersed in a cuvette during CD measurement. A permanent magnet was applied to the solution with a designated distance and magnet orientation. The position and orientation were carefully monitored during assembly to precisely control the magnitude and directions of the magnetic field, and schemes were provided in the main text and supplementary materials. The assembly and CD measurements were the same for different nanostructures.

Fixing nanorods and superstructures in polymer films. Polyacrylamide was introduced as a transparent matrix to fix the superstructures. A precursor solution containing 250 mg AM, 14 mg BIS, 3-μL 2-hydroxy-2-methylpropiophenone, and 1 mL water was prepared. Nanorods were dispersed in the precursor solution and sandwiched between a glass substrate and a cover glass. Ultraviolet light at 254 nm was used to initiate the polymerization, while a magnetic field would be applied if needed. After irradiating ultraviolet light for one minute, the superstructures were fixed in the solid film for further characterization. The fixed superstructures in polymers were dehydrated in an oven at 55° C. for one day. Afterwards, cross sections were prepared by cutting the solid films into small pieces. These cross-sections were characterized using electron microscopy to examine the nanorod alignment in the polymer matrixes.

Characterizations. Tecnai 12 transmission electron microscope operating at 120 kV was used to acquire the TEM images. The scanning electron microscopy (SEM) images were acquired using a scanning electron microscope NovaNanoSEM 450 under 10 kV. Ultraviolet-visible-near infrared (UV-Vis-NIR) spectra were measured on Ocean Optics HR2000 CG-UV-NIR high-resolution spectrometer. Optical microscopic images were acquired by ZEISS microscopy at desired magnifications. Circular dichroism (CD) spectra were measured using a Jasco J-815 CD spectrophotometer. Leica SP5 Confocal Microscope was used to acquire fluorescent images.

### Calculation of the Magnetic Field of a Permanent Magnet

The magnetic field of a permanent magnet with a cubic shape is calculated using Matlab software. The local magnetic field and field distribution are plotted in the three-dimensional space for the cubic magnet with arbitrary orientations and sizes. We consider a few parameters corresponding to the three translational and three orientational degrees of freedom of the cubic magnet in free space to describe the position and orientation of the magnet. There are X_{left}, X_{right}, Y_{left}, Y_{right}, Z_{left} and Z_{right}, which define the magnet's position, shape, and size. The subscripts donate the left and right boundaries of the magnet. To consider the magnetic field of the magnet with arbitrary orientation, we define three rotation angles along the X-, Y-, and Z-axes. After calculation, the magnetic field, the 3D model of the magnet, and the plotting domain are plotted simultaneously. The codes for calculating and plotting the magnetic field are provided as follows.

```
function B_distribuation_rotation_translation
%x1,x2,y1,y2,z1,z2: coordinates of cube magnet
% Coordination system 1: observed region (global coordination system);
% Coordination system 2: Magnet centered coordination system after translation + rotation;
%(1) Determine the observed area in CS1 ;
%(2) Determine the location of the center of the magnet in CS1;
%(3) Determine the observed area in CS2;
%(4) Calculate the B in CS2;
%(5) Transform B into CS1.
[~, ~, raw] = xlsread(‘Parameters for Cube Magnet-rotation+translation.xlsx’);
fileID = fopen(‘B-distribution-rotation−translation.txt’,‘w+’);
fprintf(fileID, ‘[Parameters for Magnet:]\n’);
magnet_length =raw{2,2}; %size of the cube magnet, Unit: m
fprintf(fileID, ‘magnet length = %.2f cm\n’, magnet_length*1E2);
M_e = raw{7,2}; %magnetizatin of element
fprintf(fileID, ‘M_e = %.4e \n’, M_e);
ad_x = raw{8,2}; %arrrow density in x direction
ad_y = raw{9,2}; %arrrow density in y direction
ad_z = raw{10,2}; %arrrow density in z direction
% rotation angles
theta_x = raw{6,2};
theta_y = raw{6,3};
theta_z = raw{6,4};
fprintf(fileID, ‘rotation x = %.1f degree\n’, theta_x);
fprintf(fileID, ‘rotation y = %.1f degree\n’, theta_y);
fprintf(fileID, ‘rotation z = %.1f degree\n’, theta_z);
% translation
translation_x = raw{4,2};
translation_y = raw{4,3};
translation_z = raw{4,4};
fprintf(fileID, ‘translation x = %.1f cm\n’, translation_x*100);
fprintf(fileID, ‘translation y = %.1f cm\n’, translation_y*100);
fprintf(fileID, ‘translation z = %.1f cm\n’, translation_z*100);
% Transform matrix for CS1 to CS2 (rotation)
TM_R_x_12 = [1, 0, 0; 0, cos(theta_x/180*pi), sin(theta_x/180*pi); 0, −sin(theta_x/180*pi), cos(theta_x/180*pi)];
TM_R_y_12 = [cos(theta_y/180*pi), 0, −sin(theta_y/180*pi); 0, 1, 0; sin(theta_y/180*pi), 0, cos(theta_y/180*pi)];
TM_R_z_12 = [cos(theta_z/180*pi), sin(theta_z/180*pi), 0; −sin(theta_z/180*pi), cos(theta_z/180*pi), 0; 0, 0, 1];
TM_R_12 = (TM_R_x_12 * TM_R_y_12 * TM_R_z_12);
% Transform matrix for CS1 to CS2 (translation)
TM_T_12 = [translation_x, translation_y, translation_z]’;
%observed region in CS1
x_left = raw{13,2}; x_right = raw{13,3};
y_left = raw{15,2}; y_right = raw{15,3};
z_left = raw{17,2}; z_right = raw{17,3};
%plot the observed region in CS1
figure;
subplot(1,2,1);
plot_observed_region(x_left, x_right, y_left, y_right, z_left, z_right);
% location of the center of the magnet in CS1 before rotation + translation
magnet_center_x = 0;
magnet_center_y = 0;
magnet_center_z = 0;
% boundaries of the magnet in CS1 before rotation + translation
x1 = − magnet_length/2; %unit:m
x2 = magnet_length/2; %unit:m
y1 = − magnet_length/2; %unit:m
y2 = magnet_length/2; %unit:m
z1 = − magnet_length/2; %unit:m
z2 = magnet_length/2; %unit:m
% the location of magent center in CS1 after rotation + translation
magnet_center = TM_R_12 * [magnet_center_x; magnet_center_y; magnet_center_z] + TM_T_12 ;
fprintf(fileID, ‘magnet center location after translation and rotation: \n’);
fprintf(fileID, ‘magnet center x = %.2f cm\n’, magnet_center(1)*1E2);
fprintf(fileID, ‘magnet center y = %.2f cm\n’, magnet_center(2)*1E2);
fprintf(fileID, ‘magnet center z = %.2f cm\n’, magnet_center(3)*1E2);
%plot the magnet in CS1
hold on;
% vortex of the magnet in CS1 before translation + rotation
V1 = [x2; y1; z2]; V2 = [x2; y2; z2]; V3 = [x2; y2; z1]; V4 = [x2; y1; z1]; %front surface, clockwise
V5 = [x1; y1; z2]; V6 = [x1; y2; z2]; V7 = [x1; y2; z1]; V8 = [x1; y1; z1]; %back surface, clockwise
% vortex of the magnet in CS1 after rotation and translation from CS5
V1_CS1 = TM_R_12 * V1 + TM_T_12;
V2_CS1 = TM_R_12 * V2 + TM_T_12;
V3_CS1 = TM_R_12 * V3 + TM_T_12;
V4_CS1 = TM_R_12 * V4 + TM_T_12;
V5_CS1 = TM_R_12 * V5 + TM_T_12;
V6_CS1 = TM_R_12 * V6 + TM_T_12;
V7_CS1 = TM_R_12 * V7 + TM_T_12;
V8_CS1 = TM_R_12 * V8 + TM_T_12;
plot_magnet(V1_CS1, V2_CS1, V3_CS1, V4_CS1, V5_CS1, V6_CS1, V7_CS1, V8_CS1);
if ad_x ~= 1 && ad_y ~= 1 && ad_z ~= 1
  [X, Y, Z] = meshgrid(x_left : (x_right − x_left)/(ad_x−1) : x_right,...
    y_left : (y_right − y_left)/(ad_y−1) : y_right, z_left : (z_right − z_left)/(ad_z−1) : z_right);
else
  error(‘arrow density must be no smaller than 2! \n’);
end
fprintf(fileID, ‘x (m) \t y (m) \t z (m) \t Flux density (T) [Bx, By, Bz] \t Normalized Flux density (T) [Bx, By, Bz]
\n’);
for i = 1 : ad_x
  for j = 1: ad_y
    for k = 1: ad_z
      %Positions in CS1
      Position_CS1 = [X(i,j,k); Y(i,j,k); Z(i,j,k)];
      fprintf(fileID, ‘%.5e \t %.5e \t %.5e \t ’, X(i,j,k), Y(i,j,k), Z(i,j,k));
      %positions in CS2
      Position_CS2 = TM_R_12’ * (Position_CS1 − TM_T_12);
      %fprintf(fileID, ‘%.5e \t %.5e \t %.5e \t ’, Position_CS2(1), Position_CS2(2), Position_CS2(3));
      B_CS2 = [magnet_cube_Bx(Position_CS2, magnet_length, M_e);...
        magnet_cube_By(Position_CS2, magnet_length, M_e);...
        magnet_cube_Bz(Position_CS2, magnet_length, M_e)];
      B_CS1 = TM_R_12 * B_CS2;
      %fprintf(fileID, ‘%.10e \t %.10e \t %.10e \t %.10e \t %.10e \t %.10e\n’,B_a_vector(1), B_a_vector(2),
B_a_vector(3),...
        % B_a_vector(1)/norm(B_a_vector), B_a_vector(2)/norm(B_a_vector), B_a_vector(3)/norm(B_a_vector));
      fprintf(fileID, ‘%.10e \t %.10e \t %.10e\t’,...
          B_CS1(1), B_CS1(2), B_CS1(3));
      fprintf(fileID, ‘%.10e \t %.10e \t %.10e\n’,...
          B_CS1(1)/norm(B_CS1), B_CS1(2)/norm(B_CS1), B_CS1(3)/norm(B_CS1));
    end
  end
end
fclose(fileID);
subplot(1,2,2);
%plot the data
data = readmatrix(‘B-distribution-rotation-translation.txt’);
x = data(:,1); y = data(:,2); z = data(:,3); bx = data(:,7);by = data(:,8); bz=data(:,9);
%%structured
xi = unique(x) ; yi = unique(y) ; zi = unique(z);
[X,Y,Z] = meshgrid(xi,yi,zi) ;
Y = reshape(y, size(X));
Z = reshape(z, size(X));
Bx_norm = reshape(bx,size(X)) ;
By_norm = reshape(by,size(X)) ;
Bz_norm = reshape(bz,size(X)) ;
q = quiver3(X.*1e2,Y.*1e2,Z.*1e2, Bx_norm, By_norm, Bz_norm);
q.AutoScaleFactor = 1;
q.MaxHeadSize = 2;
q.LineWidth = 1;
q.Color = ‘b’;
xlim([x_left*100 x_right*100]);
xticks(x_left*100 : (x_right−x_left)/5*100 : x_right*100);
xlabel(‘X (cm)’, ‘FontSize’,24);
ylim([y_left*100 y_right*100]);
yticks(y_left*100 : (y_right−y_left)/5*100 : y_right*100);
ylabel(‘Y (cm)’, ‘FontSize’,24);
zlim([z_left*100 z_right*100]);
zticks(z_left*100 : (z_right−z_left)/5*100 : z_right*100);
zlabel(‘Z (cm)’,‘FontSize’,24);
axis square;
set(gca,‘TickDir’,‘out’);
set(gca,‘LineWidth’, 2);
set(gcf,‘Position’, get(0, ‘Screensize’));
set(gca,‘FontSize’,24)
end
function [Bx] = magnet_cube_Bx(Position, magnet_length, M_e)
% the center of the magnet rests at the origin
% boundaries of the magnet in CS5
x1 = − magnet_length/2; %unit:m
x2 = magnet_length/2; %unit:m
y1 = − magnet_length/2; %unit:m
y2 = magnet_length/2; %unit:m
z1 = − magnet_length/2; %unit:m
z2 = magnet_length/2; %unit:m
mu_0 = 1.256627*10\hat{ }(−6); %vacuum permeability
F = 0;
for k = 1:2
  for m = 1:2
    F = F + (−1)\hat{ }(m+k)*log(F1(Position,x1,y1,z1,x2,y2,z2,m,k)/F2(Position,x1,y1,z1,x2,y2,z2,m,k));
  end
end
Bx = mu_0*M_e/(4*pi)*F;
end
function f1 = F1(Position,x1,y1,z1,x2,y2,z2,m,k)
if m == 1
  x_m = x1;
elseif m == 2
  x_m = x2;
end
if k == 1
  z_k = z1;
elseif k == 2
  z_k = z2;
end
Position_x = Position(1);
Position_y = Position(2);
Position_z = Position(3);
f1 = (Position_y−y1)+sqrt((Position_x−x_m)\hat{ }2+(Position_y−y1)\hat{ }2+(Position_z−z_k)\hat{ }2);
end
function f2 = F2(Position,x1,y1,z1,x2,y2,z2,m,k)
if m == 1
  x_m = x1;
elseif m == 2
  x_m = x2;
end
if k == 1
  z_k = z1;
elseif k == 2
  z_k = z2;
end
Position_x = Position(1);
Position_y = Position(2);
Position_z = Position(3);
f2 = (Position_y−y2)+sqrt((Position_x−x_m)\hat{ }2+(Position_y−y2)\hat{ }2+(Position_z−z_k)\hat{ }2);
end
function [By] = magnet_cube_By(Position, magnet_length, M_e)
% boundaries of the magnet in CS5
x1 = − magnet_length/2; %unit:m
x2 = magnet_length/2; %unit:m
y1 = − magnet_length/2; %unit:m
y2 = magnet_length/2; %unit:m
z1 = − magnet_length/2; %unit:m
z2 = magnet_length/2; %unit:m
mu_0 = 1.256627*10\hat{ }(−6); %vacuum permeability
H = 0;
for k = 1:2
  for m = 1:2
    H = H + (−1)\hat{ }(m+k)*log(H1(Position,x1,y1,z1,x2,y2,z2,m,k)/H2(Position,x1,y1,z1,x2,y2,z2,m,k));
  end
end
By = mu_0*M_e/(4*pi)*H;
end
function h1 = H1(Position,x1,y1,z1,x2,y2,z2,m,k)
if m == 1
  y_m = y1;
elseif m == 2
  y_m = y2;
end
if k == 1
  z_k = z1;
elseif k == 2
  z_k =z2;
end
Position_x = Position(1);
Position_y = Position(2);
Position_z = Position(3);
h1 = (Position_x−x1)+sqrt((Position_x−x1)\hat{ }2+(Position_y−y_m)\hat{ }2+(Position_z−z_k)\hat{ }2);
end
function h2 = H2(Position,x1,y1,z1,x2,y2,z2,m,k)
if m == 1
  y_m= y1;
elseif m == 2
  y_m = y2;
end
if k == 1
  z_k = z1;
elseif k == 2
  z_k =z2;
end
Position_x = Position(1);
Position_y = Position(2);
Position_z = Position(3);
h2 = (Position_x−x2)+sqrt((Position_x−x2)\hat{ }2+(Position_y−y_m)\hat{ }2+(Position_z−z_k)\hat{ }2);
end
function [Bz] = magnet_cube_Bz(Position, magnet_length, M_e)
% boundaries of the magnet in CS5
x1 = − magnet_length/2; %unit:m
x2 = magnet_length/2; %unit:m
y1 = − magnet_length/2; %unit:m
y2 = magnet_length/2; %unit:m
z1 = − magnet_length/2; %unit:m
z2 = magnet_length/2; %unit:m
mu_0 = 1.256627*10\hat{ }(−6); %vacuum permeability
G = 0;
for k = 1:2
  for n = 1:2
    for m = 1:2
      G = G+(−1)\hat{ }(k+n+m)*atan(g_factor(Position, x1,y1,z1,x2,y2,z2,n,m,k));
    end
  end
end
Bz = mu_0*M_e/(4*pi)*G;
end
function output = g_factor(Position, x1,y1,z1,x2,y2,z2,n,m,k)
if n == 1
  x_n = x1;
else
  x_n = x2;
end
if m == 1
  y_m = y1;
else
  y_m = y2;
end
if k == 1
  z_k = z1;
else
  z_k = z2;
end
Position_x = Position(1);
Position_y = Position(2);
Position_z = Position(3);
output = (Position_x−x_n)*(Position_y−y_m)/(Position_z−z_k)* 1/sqrt((Position_x−x_n)\hat{ }2+(Position_y−
y_m)\hat{ }2+(Position_z−z_k)\hat{ }2);
end
function plot_observed_region(x_left, x_right, y_left, y_right, z_left, z_right)
%plot the observed region in CS1
left_surface = [x_left, y_left, z_left; ...
  x_right, y_left, z_left;...
  x_right, y_left, z_right;...
  x_left, y_left, z_right];
fill3(left_surface(:,1),left_surface(:,2), left_surface(:,3), ‘k’, ‘FaceAlpha’, 0.1);
hold on;
bottom_surface = [x_right, y_left, z_left; ...
  x_left, y_left, z_left;...
  x_left, y_right, z_left;...
  x_right, y_right, z_left];
fill3(bottom_surface(:,1),bottom_surface(:,2), bottom_surface(:,3), ‘k’, ‘FaceAlpha’, 0.1);
top_surface = [x_right, y_left, z_right; ...
  x_left, y_left, z_right;...
  x_left, y_right, z_right;...
  x_right, y_right, z_right];
fill3(top_surface(:,1),top_surface(:,2), top_surface(:,3), ‘k’, ‘FaceAlpha’, 0.1);
right_surface = [x_left, y_right, z_left; ...
  x_right, y_right, z_left;...
  x_right, y_right, z_right;...
  x_left, y_right, z_right];
fill3(right_surface(:,1),right_surface(:,2), right_surface(:,3), ‘k’, ‘FaceAlpha’, 0.1);
front_surface = [x_right, y_left, z_left; ...
  x_right, y_right, z_left;...
  x_right, y_right, z_right;...
  x_right, y_left, z_right];
fill3(front_surface(:,1),front_surface(:,2), front_surface(:,3), ‘k’, ‘FaceAlpha’, 0.1);
back_surface = [x_left, y_left, z_left; ...
  x_left, y_right, z_left;...
  x_left, y_right, z_right;...
  x_left, y_left, z_right];
fill3(back_surface(:,1),back_surface(:,2), back_surface(:,3), ‘k’, ‘FaceAlpha’, 0.1);
axis equal;
end
function plot_magnet(V1, V2,V3, V4, V5, V6, V7, V8)
hold on
%plot the magnet
magnet_left = [V1′; V4′; V8′; V5′];
fill3(magnet_left(:,1),magnet_left(:,2), magnet_left(:,3), ‘k’, ‘FaceAlpha’, 0.1);
magnet_right = [V2′; V3′; V7′; V6′];
fill3(magnet_right(:,1),magnet_right(:,2), magnet_right(:,3), ‘k’, ‘FaceAlpha’, 0.1);
magnet_top = [V1′; V2′; V6′; V5′];
fill3(magnet_top(:,1),magnet_top(:,2), magnet_top(:,3), ‘r’, ‘FaceAlpha’, 0.5);
magnet_bottom = [V4′; V3′; V7′; V8′];
fill3(magnet_bottom(:,1),magnet_bottom(:,2), magnet_bottom(:,3), ‘b’, ‘FaceAlpha’, 0.5);
xlabel(‘X (m)’, ‘FontSize’,24);
ylabel(‘Y (m)’, ‘FontSize’,24);
zlabel(‘Z (m)’, ‘FontSize’,24);
end
```

### Differential and Chiral Magnetic Field Distribution

The differential and chiral magnetic field of the permanent magnet is derived based on the magnetic field of the magnet, which is calculated by the code in the above section. The differential field between magnetic fields of any two cross sections is the vector difference between them, which represents the rotation of the field in space. The differential field is also a vector, which has directions and magnitudes. For incident light along the x-axis, the differential and chiral magnetic fields in the y-z plane are calculated by subtracting the magnetic field vectors between two y-z planes (Equation 1). One example of the obtained rotation field vector is plotted in FIG. 1B. The black arrows represent the normalized local rotation magnetic field, and the two-dimensional color map represents the direction and the magnitude of the local rotation field. With this method, the chirality of the magnetic field of a permanent magnet can be calculated and plotted. Our results demonstrate the presence of a quadrupole-like chiral magnetic field of the cubic permanent magnet.

$${Δω}_{( i - j )} = [ \begin{matrix}B ( {x}_{i} , {y}_{1} , {z}_{1} ) & … & B ( {x}_{i} , {y}_{1} , {z}_{n} ) \\ ⋮ & ⋱ & ⋮ \\ B ( {x}_{i} , {y}_{n} , {z}_{1} ) & … & B ( {x}_{i} , {y}_{n} , {z}_{n} )\end{matrix} ] - [ \begin{matrix}B ( {x}_{j} , {y}_{1} , {z}_{1} ) & … & B ( {x}_{j} , {y}_{1} , {z}_{n} ) \\ ⋮ & ⋱ & ⋮ \\ B ( {x}_{j} , {y}_{n} , {z}_{1} ) & … & B ( {x}_{j} , {y}_{n} , {z}_{n} )\end{matrix} ] \qquad Eq . S 1$$

### Simulation of Magnetic Flux Density Distribution

The field solution for a permanent magnet has been developed by Furlani and is summarized here for convenience. For a cubic magnet magnetized along the z direction, its magnetic field components are given by

$${B}_{x} = \frac{{μ}_{0} {M}_{e}}{4 π} {\sum }_{k = 1}^{2} {\sum }_{m = 1}^{2} {( - 1 )}^{k + m} ln ( F ( x , y , z , {x}_{m} , {y}_{1} , {y}_{2} , {z}_{k} ) ) \qquad Eq . S 1.1$$

$${B}_{y} = \frac{{μ}_{0} {M}_{e}}{4 π} {\sum }_{k = 1}^{2} {\sum }_{m = 1}^{2} {( - 1 )}^{k + m} ln ( H ( x , y , z , {x}_{1} , {x}_{2} , {y}_{m} , {z}_{k} ) ) \qquad Eq . S 1.2$$

$${B}_{z} = \frac{{μ}_{0} {M}_{e}}{4 π} {\sum }_{k = 1}^{2} {\sum }_{n = 1}^{2} {\sum }_{m = 1}^{2} {( - 1 )}^{k + n + m} \times {tan}^{- 1} [ \frac{( x - {x}_{n} ) ( y - {y}_{m} )}{( z - {z}_{k} )} g ( x , y , z ; {x}_{n} , {y}_{m} , {z}_{k} ) ] \qquad Eq . S 1.3$$

In the above equations, Me is the magnetization of the element, (x₁, x₂), (y₁, y₂), and (z₁, z₂) are the locations of the corners and μ₀=4π×10⁻⁷ N/A² is the magnetic permeability of free-space. The expressions for F(x, y, z, xₘ, y₁, y₂, zₖ), H(x, y, z, x₁, x₂, yₘ, zₖ) and g(x, y, z; xₙ, yₘ, zₖ) are as follows

$$F ( x , y , z , {x}_{m} , {y}_{1} , {y}_{2} , {z}_{k} ) = \frac{{F}_{1} ( x , y , z , {x}_{m} , {y}_{1} , {z}_{k} )}{{F}_{2} ( x , y , z , {x}_{m} , {y}_{2} , {z}_{k} )} \qquad Eq . S 1.4$$

$$Where$$

$${F}_{1} ( x , y , z , {x}_{m} , {y}_{1} , {z}_{k} ) = ( y - {y}_{1} ) + {[ {( x - {x}_{m} )}^{2} + {( y - {y}_{1} )}^{2} + {( z - {z}_{k} )}^{2} ]}^{\frac{1}{2}} \qquad Eq . S 1.5$$

$${F}_{2} ( x , y , z , {x}_{m} , {y}_{2} , {z}_{k} ) = ( y - {y}_{2} ) + {[ {( x - {x}_{m} )}^{2} + {( y - {y}_{2} )}^{2} + {( z - {z}_{k} )}^{2} ]}^{\frac{1}{2}} \qquad Eq . S 1.6$$

### And

$$H ( x , y , z , {x}_{1} , {x}_{2} , {y}_{m} , {z}_{k} ) = \frac{{H}_{1} ( x , y , z , {x}_{1} , {y}_{m} , {z}_{k} )}{{H}_{2} ( x , y , z , {x}_{2} , {y}_{m} , {z}_{k} )} \qquad Eq . S 1.7$$

$$Where$$

$${H}_{1} ( x , y , z , {x}_{1} , {y}_{m} , {z}_{k} ) = ( x - {x}_{1} ) + {[ {( x - {x}_{1} )}^{2} + {( y - {y}_{m} )}^{2} + {( z - {z}_{k} )}^{2} ]}^{\frac{1}{2}} \qquad Eq . S 1.8$$

$${H}_{2} ( x , y , z , {x}_{2} , {y}_{m} , {z}_{k} ) = ( x - {x}_{2} ) + {[ {( x - {x}_{2} )}^{2} + {( y - {y}_{m} )}^{2} + {( z - {z}_{k} )}^{2} ]}^{\frac{1}{2}} \qquad Eq . S 1.9$$

### And

$$g ( x , y , z ; {x}_{n} , {y}_{m} , {z}_{k} ) = \frac{1}{{[ {( x - {x}_{n} )}^{2} + {( y - {y}_{m} )}^{2} + {( z - {z}_{k} )}^{2} ]}^{\frac{1}{2}}} \qquad Eq . S 1.1$$

In our simulation of the magnetic field distribution, the origin are chosen as the center of the top surface of the cubic magnet except for some special cases when noted.

### Dynamic Simulation of Magnetic Nanorod's Rotation in a Fluid

A Lagrangian trajectory approach is adopted in this work to simulate the time evolution of magnetic nanorods' rotation in a fluid. Since this simulation focuses on the rotation of magnetic NRs under external magnetic fields, the interparticle magnetic force and the magnetic field gradient-induced aggregation (packing force) are not considered here. The general equations of motion to account for the rotation of a rigid particle in the fluid are given by

$$\frac{d ( I \cdot ω )}{dt} = \sum T \qquad Eq . S2 \text{.1}$$

$$\frac{d Ω}{dt} = ω \qquad Eq . S2 \text{.2}$$

where t is the time, I is the moment of inertia, Ω and ω are the angular position and velocity vectors and ΣT represents the total torques acting on the particle.

### Coordinate Systems

To describe the three-dimensional rotation and translation of ellipsoidal particles, we employed the following coordinate systems: 1) an inertial frame of reference with its origin located at the center of the top surface of the magnet, x=[x, y, z]; 2) a particle frame with its origin at the center-of-mass of the particle and its axes being the particle principal axes, x̅=[x̅, y̅, z̅]; and 3) a comoving frame with its origin at the center-of-mass of the particle and its aces parallel to the corresponding axes of the inertial frame, x̅=[x̅, y̅, z̅]. The rotational motion is described by following the three Euler angles or the four Euler parameters (i.e., quaternions) in the particle frame.

The coordinates in the comoving frame can be transformed into ones in the particle frame by an orthonormal transformation matrix A. the matrix A is given using Euler parameters as

$$A = [ \begin{matrix}1 - 2 ( {q}_{2}^{2} + {q}_{3}^{2} ) & 2 ( {q}_{1} {q}_{2} + {q}_{3} {q}_{0} ) & 2 ( {q}_{1} {q}_{3} - {q}_{2} {q}_{0} ) \\ 2 ( {q}_{1} {q}_{2} - {q}_{3} {q}_{0} ) & 1 - 2 ( {q}_{3}^{2} + {q}_{1}^{2} ) & 2 ( {q}_{2} {q}_{3} + {q}_{1} {q}_{0} ) \\ 2 ( {q}_{1} {q}_{3} + {q}_{2} {q}_{0} ) & 2 ( {q}_{2} {q}_{3} - {q}_{1} {q}_{0} ) & 1 - 2 ( {q}_{2}^{2} + {q}_{1}^{2} )\end{matrix} ] \qquad Eq . S2 \text{.3}$$

the relation between Euler angles and Euler parameters are

$${q}_{0} = cos ( \frac{φ + ψ}{2} ) cos ( \frac{θ}{2} ) \qquad Eq . S2 \text{.4}$$

$${q}_{1} = cos ( \frac{φ - ψ}{2} ) sin ( \frac{θ}{2} ) \qquad Eq . S \text{.2} \text{.5}$$

$${q}_{2} = sin ( \frac{φ - ψ}{2} ) sin ( \frac{θ}{2} ) \qquad Eq . S2 \text{.6}$$

$${q}_{3} = sin ( \frac{φ + ψ}{2} ) cos ( \frac{θ}{2} ) \qquad Eq . S2 \text{.7}$$

or for q₂²±q₁²≠0.5

$$[ \begin{matrix}φ \\ θ \\ ψ\end{matrix} ] = [ \begin{matrix}a tan 2 ( ( {q}_{1} {q}_{3} + {q}_{2} {q}_{0} ) , ( {q}_{1} {q}_{0} - {q}_{2} {q}_{3} ) ) \\ a cos ( 1 - 2 ( {q}_{2}^{2} + {q}_{1}^{2} ) ) \\ a tan 2 ( ( {q}_{1} {q}_{3} - {q}_{2} {q}_{0} ) , ( {q}_{1} {q}_{0} + {q}_{2} {q}_{3} ) )\end{matrix} ] \qquad Eq . S2 \text{.8}$$

for q₂²±q₁²=0.5

$$[ \begin{matrix}φ \\ θ \\ ψ\end{matrix} ] = [ \begin{matrix}\pm a tan 2 ( {q}_{1} , {q}_{0} ) \\ \pm \frac{π}{2} \\ 0\end{matrix} ] \qquad Eq . S2 \text{.9}$$

the range for Euler angles are φ∈[−π, π], θ∈[0, π], ψ∈[−π, π].

### Rotation Dynamics of an Ellipsoid in Fluid

At the beginning, Euler angles are assigned to the ellipsoids with random orientations. Then Euler parameters are calculated from the initial Euler angles through Eq. S2.4-2.7. For the subsequent time steps, the time evolution of Euler parameters can be calculated by

$$[ \begin{matrix}{dq}_{0} / dt \\ {dq}_{1} / dt \\ {dq}_{2} / dt \\ {dq}_{3} / dt\end{matrix} ] = \frac{1}{2} [ \begin{matrix}- {q}_{1} {ω}_{\overline{x}} - {q}_{2} {ω}_{\overline{y}} - {q}_{3} {ω}_{\overline{z}} \\ {q}_{0} {ω}_{\overline{x}} - {q}_{3} {ω}_{\overline{y}} + {q}_{2} {ω}_{\overline{z}} \\ {q}_{3} {ω}_{\overline{x}} + {q}_{0} {ω}_{\overline{y}} - {q}_{1} {ω}_{\overline{z}} \\ - {q}_{2} {ω}_{\overline{x}} + {q}_{1} {ω}_{\overline{y}} + {q}_{0} {ω}_{\overline{z}}\end{matrix} ] \qquad Eq . S2 \text{.10}$$

where ω_{x̅}, ω_{y̅} and ω_{z̅} are the components of the particle angular velocity vector in the particle frame.

The magnetic nanorods in the fluid (i.e., water) are subject to the following torques: magnetic torque (Tₘ), hydrodynamic torque (Tₕ) and torque induced by Brownian rotation. All other torques are omitted because they are either insignificant (i.e., gravity-induced torque) or not interested (i.e., interparticle interaction-induced torque) in our simulation. Note that for Brownian rotation, we first determine the rotational displacements from the total torques in Eq. S2.1 that included only the deterministic torques (Tₘ and Tₕ). Then, the Brownian rotation, modeled in each degree of freedom as a stochastic process using Einstein's equations, is added to the previously calculated results. More details will be introduced in the flowing section 2.6.

By considering Tₘ and Tₕ, Eq. S2.1 becomes

$${I}_{\overline{x}} \frac{d {ω}_{\overline{x}}}{dt} - {ω}_{\overline{y}} {ω}_{\overline{z}} ( {I}_{\overline{y}} - {I}_{\overline{z}} ) = {T}_{m , \overline{x}} + {T}_{h , \overline{x}} \qquad Eq . S2 \text{.11}$$

$${I}_{\overline{y}} \frac{d {ω}_{\overline{y}}}{dt} - {ω}_{\overline{x}} {ω}_{\overline{z}} ( {I}_{\overline{z}} - {I}_{\overline{x}} ) = {T}_{m , \overline{y}} + {T}_{h , \overline{y}} \qquad Eq . S1 \text{.12}$$

$${I}_{\overline{z}} \frac{d {ω}_{\overline{z}}}{dt} - {ω}_{\overline{x}} {ω}_{\overline{y}} ( {I}_{\overline{x}} - {I}_{\overline{y}} ) = {T}_{m , \overline{z}} + {T}_{h , \overline{z}} \qquad Eq . S1 \text{.13}$$

where the components of the moment of inertia are (using z̅-axis as the major axis):

$${I}_{\overline{x}} = {I}_{\overline{y}} = \frac{( {β}^{2} + 1 ) {a}^{2}}{5} m , {I}_{\overline{z}} = \frac{2 {a}^{2}}{5} m ,$$

where a is the semiminor axis of the ellipsoid, β is the aspect ratio (equal to the major axis divided by the minor axis), and m is the mass of the ellipsoid; T_{m,x̅}, T_{m,y̅}, T_{m,z̅} and T_{h,x̅}, T_{h,y̅}, T_{h,z̅} are the components of torques due to magnetic force between particles and external magnetic fields and hydrodynamic drag in the particle frame, respectively.

### Magnetic Torque

In the experiment, the hybrid nanorods are weakly ferromagnetic with a magnetic dipole along their longitudinal direction. Such a dipole experiences a magnetic torque when it is subjected to an external magnetic field, and this torque is given by

$${T}_{m} = md \times B \qquad Eq . S2 \text{.14}$$

where md is the magnetic dipole of the ellipsoid and the direction is along the major axis of the ellipsoid, and its magnitude can be calculated by

$$md = V * {M}_{V} = \frac{4}{3} π {a}^{2} b * {M}_{V} \qquad Eq . S2 \text{.15}$$

where b is the semimajor axis and M_{V} is the volume magnetization of the ellipsoid. B is the magnetic flux density caused by the external magnetic field at the center of the ellipsoid, and it is calculated based on the positional relation between the ellipsoid and the cubic permanent magnet by Eq. S1.1-1.3. It is worth noting that Eq. S2.14 applies for all the 3 coordinate systems as long as the md and B are using the same coordinate system. For example, in the particle frame, Eq. S2.14 becomes

$${\overline{T}}_{m} = \overline{md} \times \overline{B} = \overline{[ 0 , 0 , 1 ]} \times \overline{B} \qquad Eq . S2 \text{.16}$$

### Hydrodynamic Torque

The analytical solutions for hydrodynamic torques acting on an ellipsoidal particle moving in a linear shear flow were previously reported in the literature. Since we assume our fluid is still, the solutions can be simplified into the following

$$[ \begin{matrix}{T}_{h , \overline{x}} \\ {T}_{h , \overline{y}} \\ {T}_{h , \overline{z}}\end{matrix} ] = [ \begin{matrix}- \frac{16 πμ {a}^{3} β}{3 ( {β}_{0} + {β}^{2} {γ}_{0} )} ( {β}^{2} + 1 ) {ω}_{\overline{x}} \\ - \frac{16 πμ {a}^{3} β}{3 ( {α}_{0} + {β}^{2} {γ}_{0} )} ( {β}^{2} + 1 ) {ω}_{\overline{y}} \\ - \frac{32 πμ {a}^{3} β}{3 ( {β}_{0} + {α}_{0} )} {ω}_{\overline{z}}\end{matrix} ] \qquad Eq . S2 \text{.17}$$

where the dimensionless parameters α₀, β₀ and γ₀ are

$${α}_{0} = {β}_{0} = \frac{{β}^{2}}{{β}^{2} - 1} + \frac{β}{2 {( {β}^{2} - 1 )}^{\frac{3}{2}}} ln [ \frac{β - \sqrt{{β}^{2} - 1}}{β + \sqrt{{β}^{2} - 1}} ] \qquad Eq . S2 \text{.18}$$

$${γ}_{0} = - \frac{2}{{β}^{2} - 1} - \frac{β}{{( {β}^{2} - 1 )}^{\frac{3}{2}}} ln [ \frac{β - \sqrt{{β}^{2} - 1}}{β + \sqrt{{β}^{2} - 1}} ] \qquad Eq . S2 \text{.19}$$

### Brownian Rotations

The root-mean-square displacements in each rotational degree of freedom because of Brownian motions satisfy Einstein's equation, which can be explicitly expressed as

$$\sqrt{〈 {( {ΔΩ}_{\overline{x}} )}^{2} 〉} = {ℜ}_{1} \sqrt{2 {D}_{\overline{x}} Δ t} \qquad Eq . S2 \text{.20}$$

$$\sqrt{〈 {( {ΔΩ}_{\overline{y}} )}^{2} 〉} = {ℜ}_{2} \sqrt{2 {D}_{\overline{y}} Δ t} \qquad Eq . S2 \text{.21}$$

$$\sqrt{〈 {( {ΔΩ}_{\overline{z}} )}^{2} 〉} = {ℜ}_{3} \sqrt{2 {D}_{\overline{z}} Δ t} \qquad Eq . S2 \text{.22}$$

where ΔΩ_{x̅}, ΔΩ_{y̅} and ΔΩ_{z̅} are the angular stochastic displacements in the particle frame during time step Δt; [symbol] ₁, [symbol] ₂ and [symbol] ₃ are the normally distributed random numbers with zero mean and unit variance; D_{x̅}, D_{y̅} and D_{z̅} are the rotational diffusion coefficients in each principal axis in the particle frame, and are given by

$${D}_{\overline{x}} = {D}_{\overline{y}} = {k}_{B} T / [ \frac{16 πμ {a}^{3}}{3} \frac{( {β}^{4} - 1 )}{\frac{( 2 {β}^{2} - 1 )}{\sqrt{{β}^{2} - 1}} ln ( β + \sqrt{{β}^{2} - 1} ) - β} ] \qquad Eq . S2 \text{.23}$$

$${D}_{\overline{z}} = {k}_{B} T / [ \frac{16 πμ {a}^{3}}{3} \frac{( {β}^{2} - 1 )}{β - \frac{1}{\sqrt{{β}^{2} - 1}} ln ( β + \sqrt{{β}^{2} - 1} )} ] \qquad Eq . S2 \text{.24}$$

where k_{B} is the Boltzmann constant, and T is the temperature in Kelvin.

### Simulation Algorithm and Details

A computer code for solving the time evolution of the rotation of an ellipsoid in the fluid is developed using MATLAB. Below are the key steps in the algorithm:
(1) a certain position relative to the cubic magnet is chosen as the simulation region. Ellipsoids' positions and orientations are randomly initialized, and their initial angular velocities are set to 0.
(2) the Euler parameters are calculated based on the Euler angles for each particle using Eq. S2.4-2.7.
(3) the transformation matrix A is calculated using Eq. S2.3.
(4) calculate the magnetic torque and hydrodynamic torque acting on the particle in the particle frame.
(5) Update particle orientation by combining both Brownian and deterministic angular displacements. Since these displacements use different notations (Brownian angular displacements: Euler angles; deterministic angular displacements: Euler parameters), to combine these two, ΔΩ̅ is first obtained and then Δω̅ due to the Brownian motion is determined. This angular velocity displacement is then added to that due to other torques. With the new angular velocity, the change of Euler parameters with time can then be derived using Eq. S2.10.
(6) Repeat Steps 2-5 to obtain the time evolution of ellipsoidal particle rotation till stopping conditions are met.

### Modeling of Chiral Superstructures and CD Spectra Simulations

The simulation of chiroptical properties of the chiral superstructures was performed using a finite element method. A chiral superstructure of two nanorods with a large separation (200 nm) was introduced, and their CD spectra were calculated (FIG. 6A). Two nanorod domains were defined with a diameter of 30 nm and an aspect ratio of 2. These two nanorod domains were surrounded by a large spherical water domain with a refractive index of 1.33. The outer layer was defined as a perfectly matched layer with a scattering boundary condition. The incident light is along the y-axis. The nanorods in the negative-y domain are set parallel to the z-axis (0 degrees), while another nanorod in the positive-y domain is rotated against the y-axis, which defines the rotation angle of the chiral superstructures. The chiral superstructures were excited by left-handed and right-handed circularly polarized light, and their extinction and absorption cross-sections were calculated. The extinction is the sum of the scattering and absorption. The chiroptical properties are characterized by the difference between the extinction under left-handed and right-handed circularly polarized light excitation. The rotation angle between the two nanorods gradually decreased from 5 degrees to 0.1 degrees. This simple model demonstrates CD responses in chiral superstructures featuring large interparticle separation and small rotation angles. To fully resolve the chiral superstructures observed in the experiments, complex models were developed by introducing multiple nanorods with only orientational order but no positional order. A set of random numbers was introduced to define the coordinates of each nanorod. The five-nanorod system has a random y-coordinate within a 500-nm length scale along the y-axis. There is at least a 100-nm separation between the nanorods to model the large separation observed in experiments. The x- and z-coordinates vary within a 50-nm×50-nm domain around their y-coordinates to ensure the lack of positional order in the model. The rotation angle of nanorods at y=−250 nm is 0 degrees, and the rotation angle of an arbitrary nanorod (x, y, z, Θ) can be calculated by Θ=ω(y±250)/500, where w is the total rotation angle between two nanorods with a 500-nm y-coordinate difference. In the simulation, ω gradually increases from −5 degrees to 5 degrees to study the dependence of CD spectra on rotation angles and the simulated CD spectra were plotted in FIG. 6B. To resolve the in-plane random distribution of nanorods observed in electron and optical microscopy images, we introduced a multilayer model containing five layers at y=−250, −125, 0, 125, and 250 nm and unidirectionally aligned nanorods in each layer. In each layer, there were five nanorods with original positions at (0,y,0), (250,y,250), (−250,y,250), (250,y,−250), and (−250,y−250). Random position shifts within ±25 nm along x- and z-axis were introduced such that the translational symmetry was broken in this model. As a result, the nanorods would only have random positions within a 50-nm×50-nm domain in different x-z planes. The nanorods within one layer shared the same rotation angle, which was defined by ω (y±250)/500. This complex model resembles a few critical features of the chiral superstructures observed in the SEM images in FIGS. 3A and 3B, including random nanorod distribution and unidirectional alignment within one cross section and constant rotation between nanorods in different layers. Their CD spectra were simulated by gradually increasing ω from −5 to 5 degrees. The simulated CD spectra in FIG. 6B showed CD responses for chiral superstructures with only orientational order. Using this five-layer model, we calculated the CD spectra of Au nanorods with their aspect ratio increasing from 2 to 3.5, which showed continuous redshift of the extinction and CD peaks.

Various embodiments of the present technology are set forth below.
1. A method of assembling a chiral superstructure, comprising: applying a quadrupole magnetic field to a plurality of magnetic nanostructures; and configuring the plurality of magnetic nanostructures into a chiral superstructure by controlling a magnitude and a direction of the quadrupole magnetic field.
2. The method of example 1, wherein the plurality of magnetic nanostructures comprises one or more of magnetic nanorods, magnetic nanoparticles, or magnetic nanodiscs.
3. The method of example 1 or example 2, wherein the plurality of magnetic nanostructures comprises non-uniform magnetic nanostructures.
4. The method of example 1 or example 2, wherein the plurality of magnetic nanostructures comprises uniform magnetic nanostructures.
5. The method of any one of example 1-4, wherein each magnetic nanostructure in the plurality of magnetic nanostructures comprises a magnetic core and a polymer shell.
6. The method of any one of examples 1-5, wherein the quadrupole magnetic field is applied to the plurality of magnetic nanostructure using a permanent magnet or an electromagnet in the shape of a cube, a disc, a horseshoe, a bar or a ring.
7. The method of any one of examples 1-6, further comprising, tuning one or more properties of the chiral superstructure by controlling the magnitude and the direction of the quadrupole magnetic field.
8. The method of example 7, wherein the one or more properties comprise chirality, orientation, shape and chiroptical properties.
9. The method of any one of examples 1-8, wherein the plurality of magnetic nanostructures comprises one or more guest materials.
10. The method of example 9, wherein the guest material is doped into the magnetic nanostructures.
11. The method of example 9 or example 10, wherein the guest material comprises one or more organic molecules, polymers, oxides, and semiconductors.
12. The method of any one of examples 9-11, further comprising transferring a chirality of the chiral superstructure to the guest material.
13. The method of example 1, further comprising fixing the chiral superstructure in a polymeric matrix.
14. A magnetic chiral superstructure, comprising a plurality of magnetic nanostructures assembled into a chiral superstructure by: applying a quadrupole magnetic field to the plurality of magnetic nanostructures; and configuring the plurality of magnetic nanostructures into a chiral superstructure by controlling a magnitude and a direction of the quadrupole magnetic field.
15. The magnetic chiral superstructure of example 14, wherein the plurality of magnetic nanostructures comprises one or more of magnetic nanorods, magnetic nanoparticles, and magnetic nanodiscs.
16. The magnetic chiral superstructure of example 14 or example 15, wherein the plurality of magnetic nanostructures comprises uniform or non-uniform magnetic nanostructures.
17. The magnetic chiral superstructure of any one of example 14-16, wherein each magnetic nanostructure in the plurality of magnetic nanostructures comprises a magnetic core and a polymer shell.
18. The magnetic chiral superstructure of any one of examples 14-17, further comprising one or more guest materials.
19. The magnetic chiral superstructure of example 18, wherein the guest material is an optical material.

Appendices A and B provide additional details of the disclosed techniques and some performance results.

### CONCLUSION

While this specification contains many specifics, these should not be construed as limitations on the scope of an invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination.

Only a few implementations are disclosed. However, variations and enhancements of the disclosed implementations and other implementations can be made based on what is described and illustrated in this specification.

We claim:

1. A method of assembling a chiral superstructure, comprising:
applying a quadrupole magnetic field to a plurality of magnetic nanostructures; and
configuring the plurality of magnetic nanostructures into a chiral superstructure by controlling a magnitude and a direction of the quadrupole magnetic field.

2. The method of claim 1, wherein the plurality of magnetic nanostructures comprises one or more of magnetic nanorods, magnetic nanoparticles, or magnetic nanodiscs.

3. The method of claim 1, wherein the plurality of magnetic nanostructures comprises non-uniform magnetic nanostructures.

4. The method of claim 1, wherein the plurality of magnetic nanostructures comprises uniform magnetic nanostructures.

5. The method of any claim 1, wherein each magnetic nanostructure in the plurality of magnetic nanostructures comprises a magnetic core and a polymer shell.

6. The method of claim 1, wherein the quadrupole magnetic field is applied to the plurality of magnetic nanostructure using a permanent magnet or an electromagnet in the shape of a cube, a disc, a horseshoe, a bar or a ring.

7. The method of claim 1, further comprising, tuning one or more properties of the chiral superstructure by controlling the magnitude and the direction of the quadrupole magnetic field.

8. The method of claim 7, wherein the one or more properties comprise chirality, orientation, shape and chiroptical properties.

9. The method of claim 1, wherein the plurality of magnetic nanostructures comprises one or more guest materials.

10. The method of claim 9, wherein the guest material is doped into the magnetic nanostructures.

11. The method of claim 9, wherein the guest material comprises one or more organic molecules, polymers, oxides, and semiconductors.

12. The method of claim 9, further comprising transferring a chirality of the chiral superstructure to the guest material.

13. The method of claim 1, further comprising fixing the chiral superstructure in a polymeric matrix.

14. A magnetic chiral superstructure, comprising:
a plurality of magnetic nanostructures assembled into a chiral superstructure by:
applying a quadrupole magnetic field to the plurality of magnetic nanostructures; and
configuring the plurality of magnetic nanostructures into a chiral superstructure by controlling a magnitude and a direction of the quadrupole magnetic field.

15. The magnetic chiral superstructure of claim 14, wherein the plurality of magnetic nanostructures comprises one or more of magnetic nanorods, magnetic nanoparticles, and magnetic nanodiscs.

16. The magnetic chiral superstructure of claim 14, wherein the plurality of magnetic nanostructures comprises uniform or non-uniform magnetic nanostructures.

17. The magnetic chiral superstructure of claim 14, wherein each magnetic nanostructure in the plurality of magnetic nanostructures comprises a magnetic core and a polymer shell.

18. The magnetic chiral superstructure of claim 14, further comprising one or more guest materials.

19. The magnetic chiral superstructure of claim 18, wherein the guest material is an optical material.
